(19) United States
(12) Patent Application Publication
(10) Pub. No.: US 2026/0204496 A1
(43) Pub. Date: Jul. 16, 2026

(54) KEY STRUCTURE

(71) Applicant: Lite-On Technology (Chang Zhou) Co., Ltd., Jiangsu Province (CN)

(72) Inventors: Bin HUANG, Jiangsu Province (CN); Xiao-Qiang Liang, Jiangsu Province (CN); Jia-Jun Jin, Jiangsu Province (CN)

(21) Appl. No.: 19/230,125

(22) Filed: Jun. 6, 2025

(30) Foreign Application Priority Data
Jan. 16, 2025 (CN) 202520109559.1

(51) Int. Cl. H01H 13/14

(52) U.S. Cl. CPC H01H 13/14

(57) ABSTRACT

A key structure includes a key cap, a first bracket, a second bracket and a third bracket. The first bracket is connected to the key cap and has a lateral surface, a first mounting portion and a second mounting portion, and the first mounting portion and the second mounting portion respectively expose a first opening and a second opening from the side surface. The second bracket is connected to the first bracket and is disposed on the first mounting portion and protrudes relative to the first opening. The third bracket is connected to the first bracket, disposed on the second mounting portion and protrudes relative to the second opening.

### BACKGROUND OF THE INVENTION

This application claims the benefit of People's Republic of China application Serial No. 202520109559.1, filed on Jan. 16, 2025, the subject matter of which is incorporated herein by reference.

### Field of the Invention

The invention relates in general to a key structure.

### Description of the Related Art

For as the current usage habits of personal computers, the keyboard is one of the indispensable input devices for inputting text, symbols or numbers. In addition, all consumer electronic products that are used in daily life or large-scale processing equipment used in the industrial sector need to be equipped with a key structure as an input device for operating the above-mentioned electronic products and processing equipment. Generally speaking, most of the keys on the keyboard device are square keycaps. A small number of keys such as the blank key (SPACE), the input key (Enter), the large letter key (Caps Lock), the shift key (Shift), etc., each has a width and a length greater than the width, and such keys are called multiple keys. However, such regular-shaped keys limit the arrangement of the keys and the appearance of the keyboard.

### SUMMARY OF THE INVENTION

According to an embodiment of the present invention, a key structure is provided. The key structure includes a keycap, a first bracket, a second bracket and a third bracket. The first bracket is connected to the keycap and has a first opening and a second opening. The second bracket is connected to the first bracket and protrudes relative to the first opening. The third bracket is connected to the first bracket and protrudes relative to the second opening, wherein the second bracket and the third bracket are separately arranged.

In an embodiment, the key structure further includes a first support element connecting the first bracket with the keycap, and the first support element is disposed corresponding to the second bracket.

In an embodiment, the keycap has a protruding area, the first support element comprises a first connection portion and a second connection portion, the first connection portion is connected to the first bracket, the second connection portion is connected to the protruding area of the keycap, the keycap comprises a plurality of connection portions, the second bracket is connected to the connection portions, and a distance between at least one of the connection portions and an edge of the protruding area is greater than a distance between the second connection portion and the edge of the protruding area.

In an embodiment, the key structure further includes a second support element and a connecting element. The second support element connects the first bracket with the keycap, wherein the second support element is disposed corresponding to the third bracket. The connecting element connects the first support element with the second support element, wherein there is a gap between the first support element and the second support element, and the gap is corresponding to the connecting element.

In an embodiment, the key structure further includes a second support element. The second support element connects the first bracket with the keycap, wherein the second support element is disposed corresponding to the third bracket. The second bracket and the third bracket are disposed along a first direction, the first support element and the second support element are arranged along a second direction, the first direction is parallel to the second direction, the first support element and the second support element respectively have a first concavity and a second concavity, the first concavity corresponds to a portion of the second bracket in position, and the second concavity corresponds to a portion of the third bracket in position.

In an embodiment, the keycap has a notch, and the notch does not overlap with the first support element along a movement direction of the keycap.

In an embodiment, the first support element has a first end and a second end opposite to the first end, the first end is fixed to the first bracket, and the second end is connected to the keycap.

In an embodiment, the first bracket comprises a connection portion, and the connection portion of the first bracket is connected to the keycap.

In an embodiment, the first bracket comprises a lateral surface, a first mounting portion and a second mounting portion, the first mounting portion and the second mounting portion respectively expose the first opening and the second opening from the lateral surface, the second bracket is disposed on the first mounting portion and connected to the first bracket, and the third bracket is disposed on the second mounting portion and connected to the first bracket.

In an embodiment, the first bracket comprises a plurality of connection portions, the keycap is connected to the connection portions of the first bracket, and the connection portions of the first bracket are arranged in a straight line.

In an embodiment, the key structure further includes a base plate and an elastic body. The elastic body is disposed between the keycap and the base plate. The keycap comprises a pressing portion, and the pressing portion overlaps with the elastic body along a movement direction of the keycap.

In an embodiment, the key structure further includes a base plate and a first support element. The first support element is disposed between the base plate and the keycap. The first support element, the first bracket and the base plate are connected along an axis.

In an embodiment, the keycap comprises a plurality of connection portions, the second bracket and the third bracket are connected to the connection portions of the keycap, and the connection portions of the keycap are arranged in a straight line.

According to another embodiment of the present invention, a key structure is provided. The key structure includes a keycap, a first bracket, a second bracket and a support element. The first bracket is connected to the keycap and has a mounting portion and an opening. The second bracket is connected to the first bracket, disposed on the mounting portion and protrudes relative to the opening. The support element connects the first bracket with the keycap.

In an embodiment, the keycap has a protruding area, and the support element is connected to the protruding area.

In an embodiment, the keycap has a notch, and the notch does not overlap with the support element along a movement direction of the keycap.

In an embodiment, the keycap comprises a pivotal hole, the support element comprises a pivotal shaft, and an inner diameter of the pivotal hole is greater than an outer diameter of the pivotal shaft.

In an embodiment, the first bracket comprises a plurality of connection portions, the keycap is connected to the connection portions of the first bracket, and the connection portions of the first bracket are arranged in a straight line.

In an embodiment, the key structure further includes a base plate. The base plate includes a plurality of connection portions. The support element is disposed between the base plate and the keycap, and the first bracket and the connection portions of the base plate are connected along an axis.

According to another embodiment of the present invention, a key structure is provided. The key structure includes a keycap, a first bracket, a second bracket and a support element. The first bracket is connected to the keycap and has a mounting portion and an opening. The second bracket is connected to the first bracket, disposed on the mounting portion and retracted relative to the opening. The support element is connected to the second bracket through the opening.

In an embodiment, the keycap has a protruding area, and the support element is connected to the protruding area.

In an embodiment, the keycap has a notch, and the notch does not overlap with the support element along a movement direction of the keycap.

In an embodiment, the keycap comprises a pivotal hole, the support element comprises a pivotal shaft, and an inner diameter of the pivotal hole is greater than an outer diameter of the pivotal shaft.

In an embodiment, the first bracket comprises a plurality of connection portions, the keycap is connected to the connection portions of the first bracket, and the connection portions of the first bracket are arranged in a straight line.

In an embodiment, the key structure further includes a base plate. The base plate includes a plurality of connection portions. The support element is disposed between the base plate and the keycap, and the first bracket and the connection portions of the base plate are connected along an axis.

According to another embodiment of the present invention, a key structure is provided. The key structure includes a base plate, a keycap, a lifting mechanism and an elastic body. The keycap is disposed on the base plate. The lifting mechanism connects the keycap with the base plate, and has a through hole, wherein the lifting mechanism includes different structures on both sides of the through hole. The elastic body is disposed between the keycap and the base plate and corresponding to the through hole.

In an embodiment, the lifting structure includes a first bracket and a second bracket. The second bracket is connected to the first bracket. The keycap comprises a plurality of connection portions, the first bracket is connected to the connection portions of the keycap, and the connection portions of the keycap are arranged in a straight line.

In an embodiment, the lifting structure further includes a support element. The support element connects the first bracket with the keycap and fixed to the first bracket. the first bracket and the base plate are connected along an axis.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B are schematic diagrams of a key structure according to an embodiment of the present invention at different viewing angles;

FIG. 2 is a schematic diagram of the key structure in FIG. 1 (but the keycap is disassembled);

FIGS. 3A and 3B are schematic diagrams of exploded views of the key structure in FIG. 1 at different viewing angles;

FIG. 4A is a schematic diagram of a cross-sectional view of the key structure in FIG. 2 along a direction 4A-4A′ (including the assembled keycap);

FIG. 4B is a schematic diagram of a cross-sectional view of the key structure in FIG. 2 along a direction 4B-4B′ (including the assembled keycap);

FIG. 4C is a schematic diagram of a cross-sectional view of the key structure in FIG. 2 along a direction 4C-4C′ (including the assembled keycap);

FIG. 4D is a schematic diagram of a cross-sectional view of the key structure in FIG. 2 along a direction 4D-4D′ (including the assembled keycap);

FIG. 4E is a schematic diagram of a cross-sectional view of the key structure in FIG. 2 along a direction 4E-4E′ (including the assembled keycap);

FIG. 4F is a schematic diagram of a cross-sectional view of the key structure in FIG. 2 along a direction 4F-4F′ (including the assembled keycap);

FIG. 4G is a schematic diagram of a cross-sectional view of the key structure in FIG. 2 along a direction 4G-4G′ (including the assembled keycap);

FIG. 5 is a schematic diagram of a cross-sectional view of a key structure according to another embodiment of the present invention;

FIGS. 6A to 6B are schematic diagrams of exploded views of a key structure according to another embodiment of the present invention at different viewing angles;

FIG. 7 is a schematic diagram of an assembly view of the key structure in FIG. 6A (but the keycap is disassembled);

FIGS. 8A to 8B are schematic diagrams of exploded views of a key structure according to another embodiment of the present invention at different viewing angles;

FIG. 9 is a schematic diagram of an assembly view of the key structure in FIG. 8A (but the keycap is disassembled);

FIGS. 10A and 10B are schematic diagrams of a key structure according to an embodiment of the present invention at different viewing angles;

FIG. 11 is an assembly schematic diagram of the key structure in FIG. 10A (but the keycap is disassembled);

FIG. 12A is a schematic diagram of a cross-sectional view of the key structure in FIG. 11 along a direction 12A-12A′ (including the assembled keycap);

FIG. 12B is a schematic diagram of a cross-sectional view of the key structure in FIG. 11 along a direction 12B-12B′ (including the assembled keycap);

FIG. 12C is a schematic diagram of a cross-sectional view of the key structure in FIG. 11 along a direction 12C-12C′ (including the assembled keycap);

FIG. 12D is a schematic diagram of a cross-sectional view of the key structure in FIG. 11 along a direction 12D-12D′ (including the assembled keycap);

FIG. 12E is a schematic diagram of a cross-sectional view of the key structure in FIG. 11 along a direction 12E-12E′ (including the assembled keycap);

FIG. 12F is a schematic diagram of a cross-sectional view of the key structure in FIG. 11 along a direction 12F-12F′ (including the assembled keycap);

FIG. 12G is a schematic diagram of a cross-sectional view of the key structure in FIG. 11 along a direction 12G-12G′ (including the assembled keycap);

FIG. 12H is a schematic diagram of a cross-sectional view of the key structure in FIG. 11 along a direction 12H-12H′ (including the assembled keycap);

FIG. 13 is a schematic diagram of a key structure 600 according to another embodiment of the invention;

FIGS. 14A and 14B are schematic diagrams of a key structure according to another embodiment of the present invention at different viewing angles;

FIG. 15 is an assembly diagram of the key structure in FIG. 14A (but the keycap is disassembled);

FIGS. 16A and 16B are exploded diagrams of the key structure in FIG. 14A at different viewing angles;

FIG. 17A is a schematic diagram of a cross-sectional view of the key structure in FIG. 15 along a direction 17A-17A′ (including the assembled keycap); and

FIG. 17B is a schematic diagram of a cross-sectional view of the key structure in FIG. 15 along a direction 17B-17B′ (including the assembled keycap).

### DETAILED DESCRIPTION OF THE INVENTION

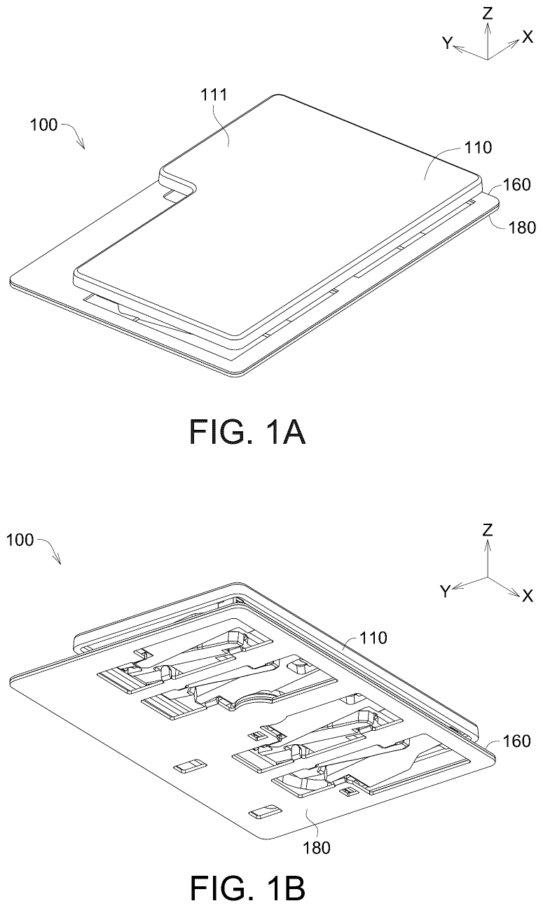

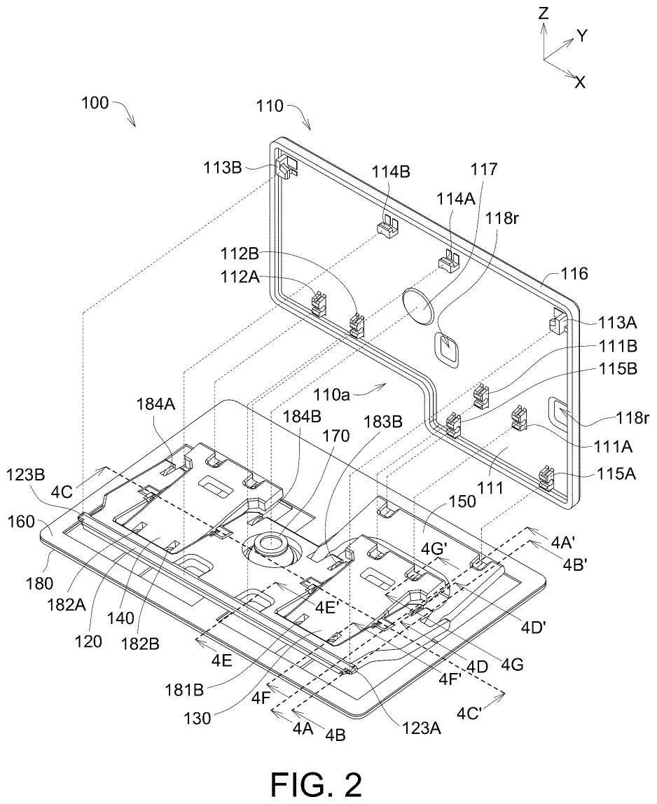

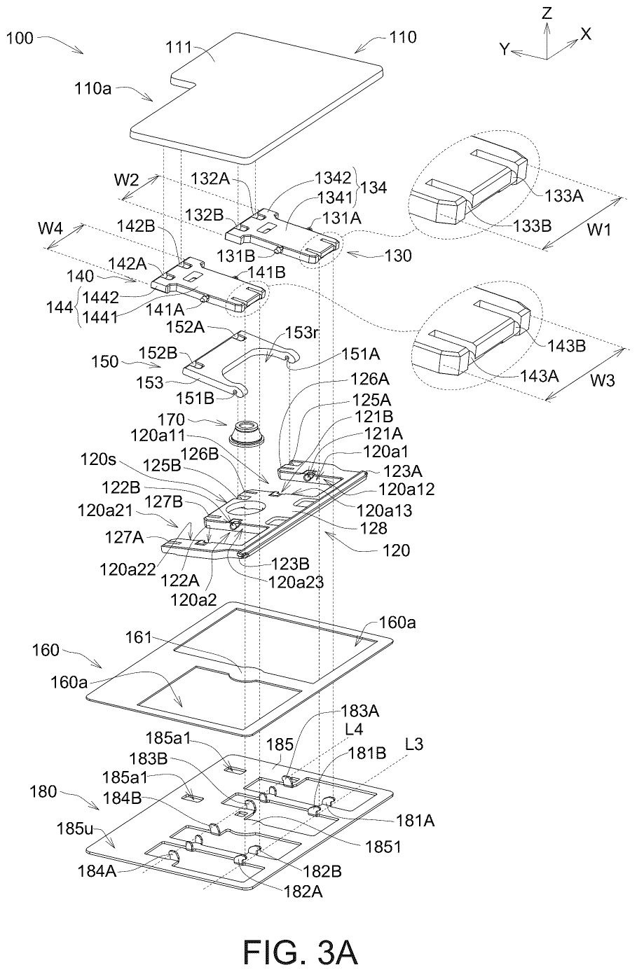

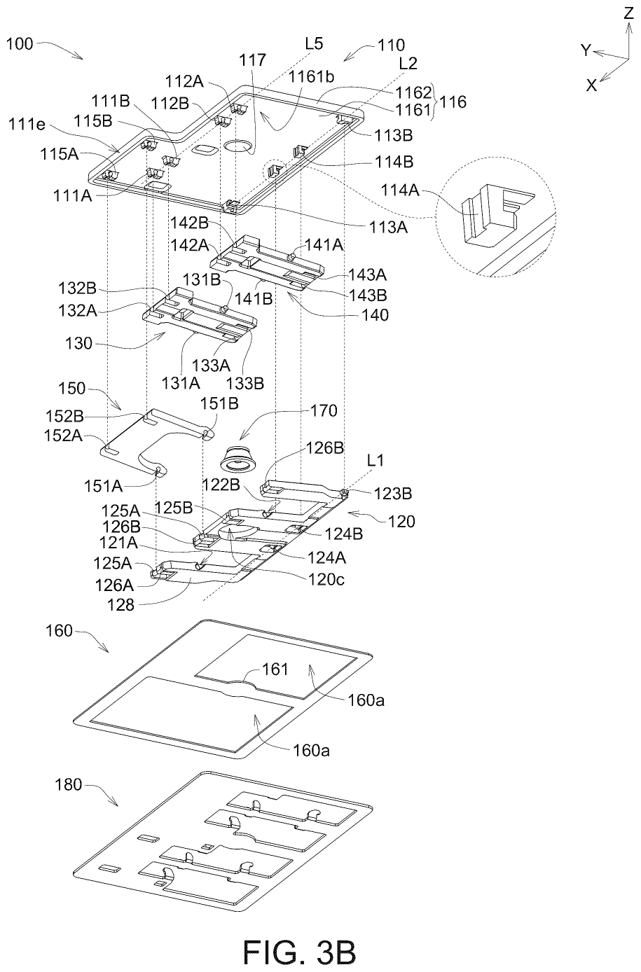

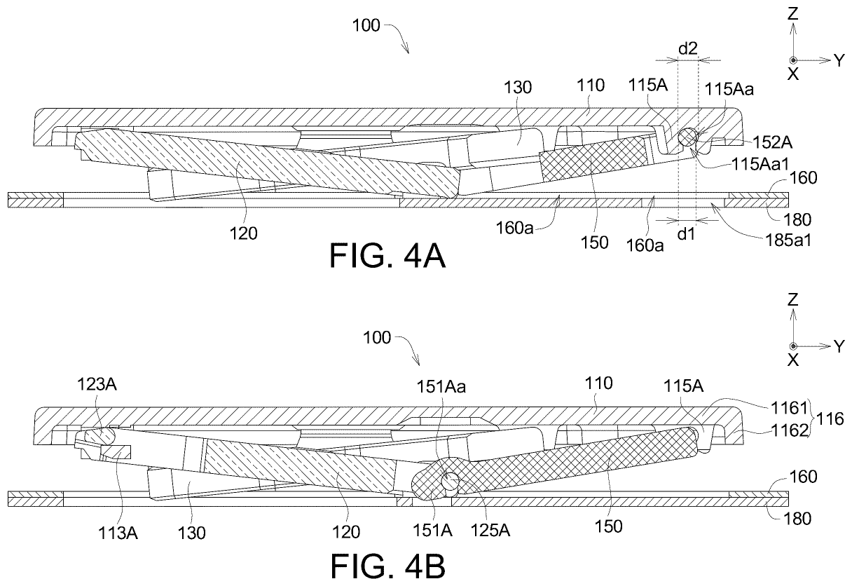

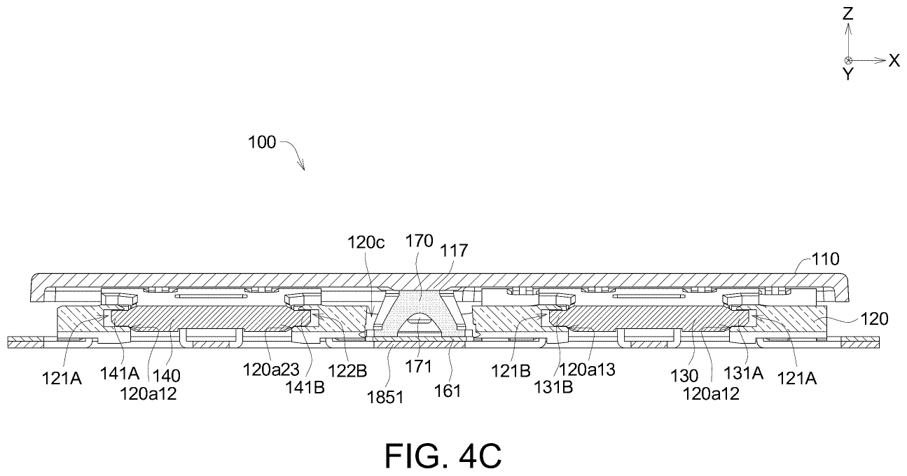

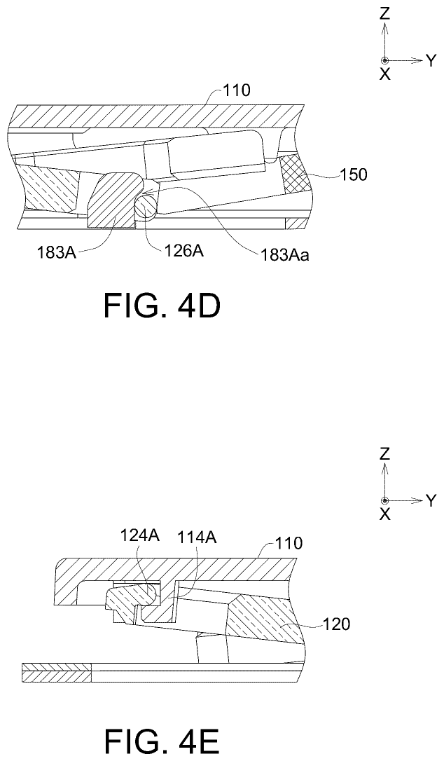

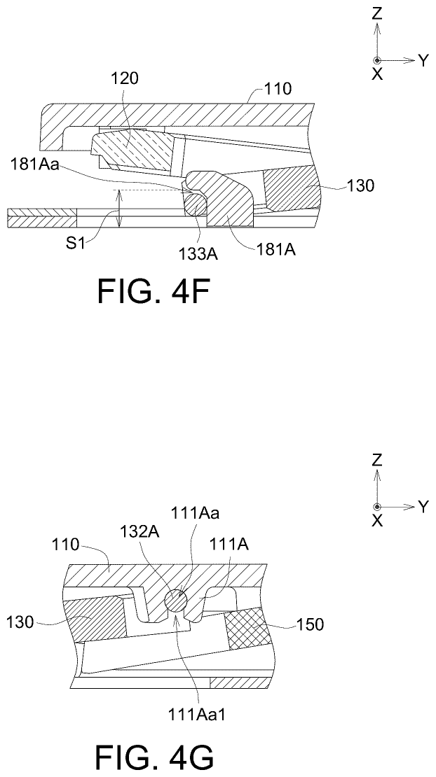

Referring to FIGS. 1A to 4G, FIGS. 1A and 1B are schematic diagrams of a key structure 100 according to an embodiment of the present invention at different viewing angles, FIG. 2 is a schematic diagram of the key structure 100 of FIG. 1 after removing the keycap 110, FIGS. 3A and 3B are schematic diagrams of exploded views of the key structure 100 in FIG. 1 at different viewing angles, FIG. 4A is a schematic diagram of a cross-sectional view of the key structure 100 in FIG. 2 along a direction 4A-4A′ (including the assembled keycap 110), FIG. 4B is a schematic diagram of a cross-sectional view of the key structure 100 in FIG. 2 along a direction 4B-4B′ (including the assembled keycap 110), FIG. 4C is a schematic diagram of a cross-sectional view of the key structure 100 in FIG. 2 along a direction 4C-4C′ (including the assembled keycap 110), FIG. 4D is a schematic diagram of a cross-sectional view of the key structure 100 in FIG. 2 along a direction 4D-4D′ (including the assembled keycap 110), FIG. 4E is a schematic diagram of a cross-sectional view of the key structure 100 in FIG. 2 along a direction 4E-4E′ (including the assembled keycap 110), FIG. 4F is a schematic diagram of a cross-sectional view of the key structure 100 in FIG. 2 along a direction 4F-4F′ (including the assembled keycap 110), and FIG. 4G is a schematic diagram of a cross-sectional view of the key structure 100 in FIG. 2 along a direction 4G-4G′ (including the assembled keycap 110).

As illustrated in FIGS. 1A to 2, the key structure 100 includes at least one keycap 110, at least one first bracket 120, at least one second bracket 130, at least one third bracket 140, at least one first support element 150, a circuit board 160, at least one elastic body 170 and a base plate 180.

As illustrated in FIG. 2, the first bracket 120, the second bracket 130 and the third bracket 140 may form a lifting mechanism, or the first bracket 120, the second bracket 130, the third bracket 140 and the first support element 150 may form a lifting mechanism. In an embodiment, one lifting mechanism, one keycap 110 and one elastic body 170 may form a key module, and the key structure 100 is, for example, a keyboard, which may include at least one key module. The aforementioned keyboard is, for example, an individual keyboard, or a built-in keyboard of an electronic product, wherein the electronic product is, for example, a notebook computer, a home appliance, and other electronic products that need input functions. In an embodiment, the lifting mechanism is, for example, a scissor mechanism. The second bracket 130 and the third bracket 140 are partially surrounded by the first bracket 120, so the second bracket 130 and the third bracket 140 may be called “inner scissor brackets”, and the first bracket 120 may be called “outer scissor bracket”. In the present embodiment, the second bracket 130 is partially surrounded by the first support element 150, so the first support element 150 may also be called “outer scissor bracket”. The first support element 150 and the first bracket 120 may be collectively called “outer scissor bracket”.

As illustrated in FIGS. 2, 3A to 3B, the first bracket 120 is connected to the keycap 110 and has a lateral surface 120s, a first mounting portion 120a1 and a second mounting portion 120a2, and the first mounting portion 120a1 and the second mounting portion 120a2 respectively expose a first opening 120a11 and a second opening 120a21 from the lateral surface 120s. The second bracket 130 is connected to the first bracket 120, is disposed on the first mounting portion 120a1 and protrudes relative to the first opening 120a11. The third bracket 140 is connected to the first bracket 120, is disposed on the second mounting portion 120a2 and protrudes relative to the second opening 120a21. In the present embodiment, due to the second bracket 130 protruding from the first bracket 120, it may support the corresponding part of the keycap 110. As a result, the keycap 110 may be designed into different shapes (or “special-shaped keycap”). For example, the keycap 110 includes a protruding area (or a protruding portion) 111, and the second bracket 130 may be disposed adjacent to the protruding area 111 of the keycap 110 to support the keycap 110 adjacent to the protruding area 111. In addition, in response to the different shapes of the keycap (or special-shaped keycap), the first bracket 120 and the second bracket 130 may be designed to cooperate with each other for supporting the keycaps of different shapes.

In addition, the “connection” in this description includes, for example, movable connection relationships such as “pivot”, “sliding”, etc., but it is not limited to this. Accordingly, the “connection portion” in this description may be a similar term such as “a pivoting portion”, “a sliding portion”, etc., but it is not limited thereto. The mounting portion in this description is, for example, one of a concave hole and a convex portion, and what is connected to the mounting portion is, for example, the other of the concave hole and the convex portion.

As illustrated in FIG. 3B, the keycap 110 includes a first connection portion 111A, a first connection portion 111B, a second connection portion 112A, a second connection portion 112B, a third connection portion 113A, a third connection portion 113B, a fourth connection portion 114A, a fourth connection portion 114B, a fifth connection portion 115A, a fifth connection portion 115B and a cap body 116. The cap body 116 includes a top plate 1161 and a lateral plate 1162, wherein the lateral plate 1162 is connected to the edge of the top plate 1161. The first connection portions 111A and 111B, the second connection portions 112A and 112B, the third connection portions 113A and 113B, and the fourth connection portions 114A and 114B are connected to a lower surface 1161b of the top plate 1161.

As illustrated in FIG. 3B, the first connection portion 111A is the same as or similar to the first connection portion 111B in structure, the second connection portion 112A is the same as or similar to the second connection portion 112B in structure, the third connection portion 113A is the same as or similar to the third connection portion 113B in structure, the fourth connection portion 114A is the same as or similar to the fourth connection portion 114B in structure, and the fifth connection portion 115A is the same as or similar to the fifth connection portion 115B in structure.

As illustrated in FIGS. 2 and 3A to 3B, the keycap 110 may be connected to the first bracket 120, the second bracket 130, the third bracket 140, and the first support element 150. For example, the first connection portions 111A and 111B may be connected to the second bracket 130, the second connection portions 112A and 112B may be connected to the third bracket 140, the third connection portions 113A and 113B, and the fourth connection portions 114A and 114B may be connected to the first bracket 120, and the fifth connection portions 115A and 115B may be connected to the first support element 150.

As illustrated in FIG. 3B, the keycap 110 includes a plurality of connection portions which are arranged in a straight line, and the second bracket 130 and the third bracket 140 are connected to the connection portions of the keycap 110. For example, the first connection portions 111A and 111B and the second connection portions 112A and 112B of the keycap 110 may be arranged in a straight line L5 (for example, substantially parallel to the X-axis), wherein the second bracket 130 and the third bracket 140 may be connected to the first connection portions 111A and 111B and the second connection portions 112A and 112B which are arranged in a straight line, and such a coaxial connection (for example, one axis) may reduce the complexity of the mechanism design.

As illustrated in FIGS. 2, 3B and 4C, the keycap 110 further includes a pressing portion 117, wherein the pressing portion 117 is connected to the lower surface 1161b of the top plate 1161 and protrudes relative to the lower surface 1161b. The pressing portion 117 overlaps with the elastic body 170 along a movement direction (for example, the Z-axis direction) of the keycap 110. The pressing portion 117 and the elastic body 170 remain in contact, so that an impact noise may be reduced when the keycap 110 is pressed.

As illustrated in FIG. 2, the keycap 110 further includes a recess 118r, and the recess 118r is formed in the top plate 1161 and recessed relative to the lower surface 1161b. The recess 118r overlaps with a connecting arm (which has, for example, the first connection portions 151A and 151B described later) of the first support element 150 along the movement direction (for example, the Z-axis direction) of the keycap 110. When the keycap 110 is in a pressed state, the connection portion of the first support element 150 may be partially located in the recess 118r, so as to avoid interference with the physical material of the keycap 110.

As illustrated in FIGS. 2, 3B and 4C, the first bracket 120 may connect the keycap 110, the second bracket 130, the third bracket 140, the first support element 150 and the base plate 180. The first bracket 120 includes a plurality of first connection portions 121A and 121B, a plurality of second connection portions 122A and 122B, a plurality of third connection portions 123A and 123B, a plurality of fourth connection portions 124A and 124B, a plurality of fifth connection portions 125A and 125B, a plurality of sixth connection portions 126A and 126B, a plurality of seventh connection portions 127A and 127B and a first bracket body 128.

The first connection portion 121A is the same as or similar to the first connection portion 121B in structure, the second connection portion 122A is the same as or similar to the second connection portion 122B in structure, the third connection portion 123A is the same as or similar to the third connection portion 123B in structure, the fourth connection portion 124A is the same as or similar to the fourth connection portion 124B in structure, the fifth connection portion 125A is the same as or similar to the fifth connection portion 125B in structure, the sixth connection portion 126A is the same as or similar to the sixth connection portion 126B in structure, and the seventh connection portion 127A is the same as or similar to the seventh connection portion 127B in structure.

As illustrated in FIGS. 2, 3A and 3B, the first connection portions 121A and 121B and the second connection portions 122A and 122B are, for example, pivotal holes, which are disposed in the first bracket body 128, and the third connection portions 123A and 123B, the fourth connection portions 124A and 124B, the fifth connection portions 125A and 125B and the sixth connection portions 126A and 126B are, for example, pivotal shafts, which are connected to the first bracket body 128. The first bracket body 128 has the aforementioned lateral surface 120s. In an embodiment, the third connection portions 123A and 123B, the fourth connection portions 124A and 124B, the fifth connection portions 125A and 125B, the sixth connection portions 126A and 126B and the first bracket body 128 form, for example, an integrally formed structure. For example, he integrated first bracket 120 may be formed by an injection molding technology. In terms of material, the first bracket 120 is, for example, made of plastic.

As illustrated in FIGS. 2, 3A and 3B, the first connection portions 121A and 121B of the first bracket 120 may be connected to the second bracket 130. The second connection portions 122A and 122B of the first bracket 120 may be connected to the third bracket 140. The third connection portions 123A and 123B and the fourth connection portions 124A and 124B of the first bracket 120 may be connected to the keycap 110. The fifth connection portions 125A and 125B of the first bracket 120 may be connected to the first support element 150, and the sixth connection portions 126A and 126B and the seventh connection portions 127A and 127B may be connected to the base plate 180.

As illustrated in FIG. 4C, the first mounting portion 120a1 of the first bracket 120 has a first inner lateral surface 120a12 and a second inner lateral surface 120a13 opposite to the first inner lateral surface 120a12, the first connection portion 121A is recessed relative to the first inner lateral surface 120a12, and the first connection portion 121B is recessed relative to the second inner lateral surface 120a13. Similarly, the second mounting portion 120a2 of the first bracket 120 has a third inner lateral surface 120a22 and a fourth inner lateral surface 120a23 opposite to the third inner lateral surface 120a22, the second connection portion 122A is recessed relative to the third inner lateral surface 120a22, and the second connection portion 122B is recessed relative to the fourth inner lateral surface 120a23.

As illustrated in FIGS. 3A, 3B, 4B and 4E, the third connection portions 123A and 123B of the first bracket 120 are respectively connected to the third connection portions 113A and 113B of the keycap 110, and the fourth connection portions 124A and 124B of the first bracket 120 are respectively connected to the fourth connection portions 114A and 114B of the keycap 110. In the present embodiment, the third connection portions 123A and 123B and the fourth connection portions 124A and 124B of the first bracket 120 may be arranged in a straight line L1 (e.g., substantially parallel to the X-axis), and the third connection portions 113A and 113B and the fourth connection portions 114A and 114B of the keycap 110 are also arranged in a straight line L2 (e.g., substantially parallel to the X-axis) correspondingly. In the present embodiment, a plurality of the connection portions (e.g., the third connection portions 113A and 113B and the fourth connection portions 114A and 114B) of the keycap 110 are coaxially connected with a plurality of the connection portions (e.g., the third connection portions 123A and 123B and the fourth connection portions 124A and 124B) of the first bracket 120, and accordingly it may it may reduce the complexity of the mechanism design. In addition, a plurality of the connection portions (e.g., the third connection portions 113A and 113B and the fourth connection portions 114A and 114B) of the keycap 110 are disposed adjacent to a side of the keycap 110, and accordingly it may provide an edge support effect and accordingly may increase the stability of the keycap 110 when the keycap 110 is pressed. In addition, the fourth connection portions 124A and 124B of the first bracket 120 are located between the third connection portion 123A and the third connection portion 123B, and accordingly it may provide more supporting points (e.g., four) and may increase the stability of the first bracket 120 supporting the keycap 110. In another embodiment, the number of the fourth connection portions of the first bracket 120 may be more than two or be one, and the number of the fourth connection portions of the keycap 110 may be changed accordingly.

As illustrated in FIGS. 3B and 4C, the first bracket 120 has a through hole 120c, and the through hole 120c allows the elastic body 170 to pass through and press against the keycap 110.

As illustrated in FIGS. 2, 3A to 3B, the second bracket 130 and the third bracket 140 are arranged along a first direction (for example, the X-axis direction). The second bracket 130 and the third bracket 140 may be completely separated. The second bracket 130 includes a plurality of first connection portions 131A and 131B, a plurality of second connection portions 132A and 132B, a plurality of third connection portions 133A and 133B and a second bracket body 134, wherein the first connection portions 131A and 131B, the second connection portions 132A and 132B, and the third connection portions 133A and 133B are, for example, pivotal shafts, which may be connected to the second bracket body 134.

The first connection portion 131A is the same as or similar to the first connection portion 131B in structure, the second connection portion 132A is the same as or similar to the second connection portion 132B in structure, and the third connection portion 133A is the same as or similar to the third connection portion 133B in structure.

As illustrated in FIGS. 2, 3A, and 3B, the second bracket body 134 includes a first portion 1341 and a second portion 1342 connected to the first portion 1341. The first connection portions 131A and 131B and the third connection portions 133A and 133B are disposed in the first portion 1341, and the second connection portions 132A and 132B are disposed in the second portion 1342. The first portion 1341 has a width W1 smaller than a width W2 of the second portion 1342. The first portion 1341 may correspond to the first mounting portion 120a1 of the first bracket 120 in position. For example, the first portion 1341 is at least partially located in the first mounting portion 120a1. The second portion 1342 is located outside the first mounting portion 120a1. When the key structure 100 is in the pressed state, the lateral surface 120s of the first bracket 120 may face the second portion 1342.

As illustrated in FIGS. 2, 3A to 3B and 4C, the first connection portions 131A and 131B of the second bracket 130 may be connected to the first bracket 120. For example, the first connection portions 121A and 121B of the first bracket 120 are, for example, pivotal holes, and the first connection portions 131A and 131B of the second bracket 130 are, for example, pivotal shafts, and the first connection portions 131A and 131B may be connected to the first connection portions 121A and 121B of the first bracket 120 respectively.

As illustrated in FIGS. 3A to 3B and 4G, the second connection portions 132A and 132B (for example, pivotal shafts) of the second bracket 130 may be connected to the first connection portions 111A and 111B (for example, having pivotal holes) of the keycap 110 respectively. Taking the first connection portion 111A as an example, the first connection portion 111A has a pivotal hole 111Aa, and the second connection portion 132A of the second bracket 130 is connected to the pivotal hole 111Aa of the first connection portion 111A. An inner diameter of the pivotal hole 111Aa is substantially equal to an outer diameter of the second connection portion 132A, so the relative movement between the second connection portion 132A and the pivotal hole 111Aa is pure rotation without sliding. The first connection portion 111A further has an opening 111Aa1, and the opening 111Aa1 is interconnected to the pivotal hole 111Aa. The inner diameter of the opening 111Aa1 is smaller than the inner diameter of the pivotal hole 111Aa, so that the second connection portion 132A may be prevented from easily detaching from the pivotal hole 111Aa.

The connection method and/or the connection structure of the second connection portion 132B of the second bracket 130 and the first connection portion 111B of the keycap 110 are the same as or similar to the connection method and/or the connection structure of the second connection portion 132A of the second bracket 130 and the first connection portion 111A of the keycap 110, and they will not be repeated here.

As illustrated in FIG. 3B, the third bracket 140 includes a plurality of first connection portions 141A and 141B, a plurality of second connection portions 142A and 142B, a plurality of third connection portions 143A and 143B, and a third bracket body 144, wherein the first connection portions 141A and 141B, the second connection portions 142A and 142B, and the third connection portions 143A and 143B are, for example, pivotal shafts, which may be connected to the third bracket body 144.

The first connection portion 141A is the same as or similar to the first connection portion 141B in structure, the second connection portion 142A is the same as or similar to the second connection portion 142B in structure, and the third connection portion 143A is the same as or similar to the third connection portion 143B in structure.

As illustrated in FIGS. 2, 3A, and 3B, in the present embodiment, the third bracket 140 is the same as or identical to the second bracket 130 in structure. For example, the third bracket body 144 includes a first portion 1441 and a second portion 1442 connected to the first portion 1441. The first connection portions 141A and 141B and the third connection portions 143A and 143B are disposed on the first portion 1441, and the second connection portions 142A and 142B are disposed on the second portion 1442. A width W3 of the first portion 1441 is smaller than a width W4 of the second portion 1442. The first portion 1441 may correspond to the second mounting portion 120a2 of the first bracket 120 in position. For example, the first portion 1441 is at least partially located in the second mounting portion 120a2. The second portion 1442 is located outside the second mounting portion 120a2. When the key structure 100 is in the pressed state, the lateral surface 120s of the first bracket 120 may face the second portion 1442.

As illustrated in FIGS. 2, 3A to 3B and 4C, the first connection portions 141A and 141B of the third bracket 140 may be connected to the first bracket 120. For example, the second connection portions 122A and 122B of the first bracket 120 are, for example, pivotal holes, and the first connection portions 141A and 141B of the third bracket 140 are, for example, pivot shafts, and the first connection portions 141A and 141B may be connected to the second connection portions 122A and 122B of the first bracket 120 respectively.

As illustrated in FIGS. 3A and 3B, the second connection portions 142A and 142B (e.g., pivotal shafts) of the third bracket 140 may be connected to the second connection portions 112A and 112B (e.g., having pivotal holes) of the keycap 110 respectively. The connection method and/or the connection structure of the second connection portion 142A of the third bracket 140 and the second connection portion 112A of the keycap 110 are the same as or similar to the connection method and/or the connection structure of the second connection portion 132A and the first connection portion 111A of the keycap 110, and they will not be repeated here. In addition, the connection method and/or the connection structure of the second connection portion 142B of the third bracket 140 and the second connection portion 112B of the keycap 110 are the same as or similar to the connection method and/or the connection structure of the second connection portion 142A of the third bracket 140 and the second connection portion 112A of the keycap 110, and they will not be repeated here.

In the present embodiment, the key structure 100 is a multiple key, and its length along the X-axis is greater than its length along the Y-axis. In another embodiment, the key structure 100 may omit the corresponding portions of the third bracket 140 and the first support element 120, so that the length (for example, along the X-axis) of the key structure 100 is shortened, and the key structure 100 becomes a single key after shortening length.

As illustrated in FIGS. 2, 3A and 3B, the first support element 150 may be disposed corresponding to the second bracket 130. The first support element 150 may be connected to the keycap 110 and the first bracket 120. The first support element 150 overlaps with the protruding area 111 of the keycap 110 along the movement direction (for example, along the Z-axis) of the keycap 110, so that the protruding area 111 of the keycap 110 may be supported, and the stability of the keycap 110 is increase when being pressed (the protruding area 111 of the keycap 110 will be suspended in lack of the support of the first support element 150). In addition, the keycap 110 further has a notch 110a, and the protruding area 111 protrudes relative to the lateral surface of the notch 110a. The notch 110a and the first support element 150 do not overlap at all along the movement direction (e.g., the Z-axis direction) of the keycap 110, and/or the notch 110a and the bracket (e.g., the first bracket 120, the second bracket 130 and/or the third bracket 140) do not overlap at all along the movement direction (e.g., the Z-axis direction) of the keycap 310, that is, the first support element 150, the first bracket 120, the second bracket 130 and/or the third bracket 140 are exposed from the notch 110a (viewed in a top direction).

As illustrated in FIGS. 2, 3A and 3B, the first support element 150 includes a plurality of first connection portions 151A and 151B, a plurality of second connection portions 152A and 152B and a support element body 153. The first connection portions 151A and 151B and the second connection portions 152A and 152B may be disposed on the support element body 153. The first connection portion 151A is similar to or the same as the first connection portion 151B in structure, and the second connection portion 152A is similar to or the same as the second connection portion 152B in structure.

In addition, a distance (for example, along the Y-axis direction) between at least one of a plurality of the connection portions (for example, the first connection portions 111A and 111B) of the keycap 110 and an edge 111e of the protruding area 111 is greater than a distance between the second connection portion 152A of the first support element 150 and the edge 111e of the protruding area 111.

As illustrated in FIGS. 2, 3A and 3B, the first connection portions 151A and 151B are, for example, pivotal holes, and the second connection portions 152A and 152B are, for example, pivot shafts. The support element body 153 has a concavity 153r, and the second bracket 130 may be partially located in the concavity 153r after the first support element 150 and the first bracket 120 are assembled. For example, the second portion 1342 of the second bracket 130 may be at least partially located in the concavity 153r.

As illustrated in FIGS. 3A, 3B and 4B, the first connection portions 151A and 151B of the first support element 150 are connected to the first bracket 120. For example, the first connection portions 151A and 151B of the first support element 150 may be connected to the fifth connection portions 125A and 125B of the first bracket 120 respectively. For example, the first connection portion 151A has a pivotal hole 151Aa, and the fifth connection portion 125A is, for example, a pivot shaft, and the fifth connection portion 125A is connected to the pivotal hole 151Aa. An inner diameter of the pivotal hole 151Aa is substantially equal to an outer diameter of the fifth connection portion 125A, so the relative movement between the fifth connection portion 125A and the pivotal hole 151Aa is pure rotation without sliding. The connection method and/or the connection structure of the first connection portion 151B of the first support element 150 and the fifth connection portion 125B of the first bracket 120 are the same as or similar to the connection method and/or the connection structure of the first connection portion 151A of the first support element 150 and the fifth connection portion 125A of the first bracket 120, and they will not be repeated here.

In the present embodiment, the first support element 150 and the first bracket 120 are buckled, and it helps to improve the assembly performance and reduce the complexity of the structure and simplify the assembly process.

As illustrated in FIGS. 3A, 3B and 4A, the second connection portion of the first support element 150 is connected to the protruding area 111. For example, the second connection portions 152A and 152B of the first support element 150 are, for example, pivotal shafts, which may be connected to the fifth connection portions 115A and 115B of the keycap 110 respectively. The fifth connection portions 115A and 115B may be disposed in the protruding area 111, so that the first support element 150 is connected to (or supports) the protruding area 111 of the keycap 110. The second connection portion 152A is, for example, a pivotal shaft having an outer diameter d1 along the Y-axis. The fifth connection portion 115A has a pivotal hole 115Aa having an inner diameter d2 along the Y-axis. In the present embodiment, the inner diameter d2 is larger than the outer diameter d1, and accordingly it may provide a movable clearance so that the keycap 110 and the first support element 150 may move relative to each other with less effort (if the movable clearance is omitted, the keycap 110 and the first support element 150 will interfere excessively during relative movement). The fifth connection portion 115A has an opening 115Aa1, and the opening 115Aa1 is interconnected to the pivotal hole 115Aa. The inner diameter of the opening 115Aa1 is smaller than the inner diameter d2 of the pivotal hole 115Aa, so that the second connection portion 152A may be prevented from easily detaching from the pivotal hole 115Aa.

In addition, the connection method and/or the connection structure of the second connection portion 152B of the first support element 150 and the fifth connection portion 115B of the keycap 110 are the same as or similar to the connection method and/or the connection structure of the second connection portion 152A of the first support element 150 and the fifth connection portion 115A of the keycap 110, and they will not be repeated here.

As illustrated in FIGS. 3A and 3B, the circuit board 160 is, for example, a membrane switch circuit board. Although not illustrated, the circuit board 160 is a multilayer structure which at least includes at least one first trace and at least one second trace, wherein the corresponding first trace and second trace may selectively contact or be spaced from each other. The first trace and the second trace overlapping the elastic body 170 along the Z-axis form a switch, and when the switch is triggered, a trigger signal may be generated. The circuit board 160 has at least one through hole 160a, and the through hole 160a may expose a plurality of the connection portions of the base plate 180 to allow the connection portions of the base plate 180 to be connected to corresponding elements. The through hole 160a may provide a collision-avoidance space. For example, as illustrated in FIG. 4A, the fifth connection portion 115A overlaps with the through hole 160a along the movement direction (e.g., Z-axis) of the keycap 110. As a result, when the key structure 100 is in the pressed state, the fifth connection portion 115A may be partially located in the through hole 160a to avoid interference with the physical material of the circuit board 160, and accordingly it may avoid impact noise. In addition, the circuit board 160 includes at least one carrying portion 161, and the carrying portion 161 may receive the elastic body 170.

As illustrated in FIGS. 3A, 3B and 4C, the elastic body 170 may be disposed on the carrying portion 161 of the circuit board 160. When the elastic body 170 is deformed (e.g., the keycap 110 is pressed), a trigger portion 171 of the elastic body 170 (the trigger portion 171 is illustrated in FIG. 4C) presses against the switch (not illustrated) in the carrying portion 161. When the switch is triggered, the trigger signal (not illustrated) may be transmitted to a processor (not illustrated), and the processor executes the corresponding function. In an embodiment, the elastic body 170 may be made of rubber, or may be a spring.

As illustrated in FIGS. 3A and 3B, the base plate 180 includes a plurality of first connection portions 181A and 181B, a plurality of second connection portions 182A and 182B, a plurality of third connection portions 183A and 183B, a plurality of fourth connection portions 184A and 184B and a base plate body 185. The first connection portion 181A is similar to or the same as the first connection portion 181B in structure, the second connection portion 182A is similar to or the same as the second connection portion 182B in structure, the third connection portion 183A is similar to or the same as the third connection portion 183B in structure, and the fourth connection portion 184A is similar to or the same as the fourth connection portion 184B in structure.

As illustrated in FIGS. 3A and 3B, the base plate body 185 has a surface 185u, wherein the first connection portions 181A and 181B, the second connection portions 182A and 182B, the third connection portions 183A and 183B, and the fourth connection portions 184A and 184B may protrude relative to the surface 185u. In an embodiment, the first connection portions 181A and 181B, the second connection portions 182A and 182B, the third connection portions 183A and 183B, the fourth connection portions 184A and 184B and the base plate body 185 form, for example, an integrally formed structure. In terms of the manufacturing process, the integrated base plate 180 may be form by stamping and/or bending. In terms of the material, the base plate 180 may be made of metal, but may also be plastic.

As illustrated in FIGS. 3A and 3B, the first connection portions 181A and 181B of the base plate 180 may be connected to the third connection portions 133A and 133B of the second bracket 130, the second connection portions 182A and 182B may be connected to the third connection portions 143A and 143B of the third bracket 140, and the third connection portions 183A and 183B and the fourth connection portions 184A and 184B may be connected to the first bracket 120.

As illustrated in FIGS. 3A and 3B, in the present embodiment, the first connection portions 181A and 181B and the second connection portions 182A and 182B of the base plate 180 may be arranged in a straight line L3 (e.g., substantially parallel to the X-axis), so that the third connection portions 133A and 133B of the second bracket 130 and the third connection portions 143A and 143B of the third bracket 140 may be connected to the base plate 180 along the straight line L3. In other words, the second bracket 130 and the third bracket 140 are connected in the same straight line in the base plate 180, and such a coaxial connection may reduce the complexity of the mechanism design. In addition, the third connection portions 183A and 183B and the fourth connection portions 184A and 184B of the base plate 180 may be arranged in a straight line L4 (for example, substantially parallel to the X-axis), the sixth connection portions 126A and 126B and the seventh connection portions 127A and 127B of the first bracket 120 may be arranged in a straight line (for example, substantially parallel to the X-axis), and the first bracket 120 may be connected to the base plate 180 along a straight line. In other words, the first bracket 120 is connected in the same straight line in the base plate 180, and such a coaxial connection may reduce the complexity of the mechanism design.

As illustrated in FIGS. 2 and 3A, the fifth connection portions 125A and 125B and the sixth connection portions 126A and 126B of the first bracket 120 may be arranged in a straight line (for example, substantially parallel to the X-axis). As a result, when the first support element 150, the first bracket 120 and the base plate 180 are assembled, the first connection portions 151A and 151B of the first support element 150, the fifth connection portions 125A and 125B of the first bracket 120 and the third connection portions 183A and 183B of the base plate 180 are substantially connected along the straight line L4, and such a coaxial connection may reduce the complexity of the mechanism design.

As illustrated in FIGS. 3A and 4A, the base plate body 185 of the base plate 180 further has at least one through hole 185a1. The fifth connection portion 115A overlaps with the through hole 185a1 along the movement direction (e.g., Z-axis) of the keycap 110. As a result, when the key structure 100 is in the pressed state, the fifth connection portion 115A may be partially located in the through hole 185a1 to avoid interference with the physical material of the base plate 180, and accordingly it may avoid impact noise. In addition, the base plate body 185 of the base plate 180 further includes the carrying portion 1851. The carrying portion 1851 and the carrying portion 161 of the circuit board 160 overlap along the movement direction (e.g. the Z-axis) of the keycap 110. When the key structure 100 is in the pressed state, the carrying portion 1851 of the base plate 180 may stop the trigger portion 171 of the elastic body 170, so that the switch of the circuit board 160 may be accurately triggered by the trigger portion 171 when the keycap 110 is in a preset descending stroke.

As illustrated in FIGS. 3A to 3B and 4F, taking the first connection portion 181A as an example, the first connection portion 181A has a concavity 181Aa, and the third connection portion 133A of the second bracket 130 is, for example, a pivotal shaft, which may be connected to the concavity 181Aa. The concavity 181Aa provides a sliding space S1 extending along the Z-axis, so that the third connection portion 133A may slide in the concavity 181Aa along the Z-axis, and accordingly it may avoid the excessive interference between the third connection portion 133A and the physical material of the first connection portion 181A. The connection method and/or the connection structure of the first connection portion 181B of the base plate 180 and the third connection portion 133B of the second bracket 130 are the same as or similar to the connection method and/or the connection structure of the first connection portion 181A of the base plate 180 and the third connection portion 133A of the second bracket 130, and they will not be repeated here.

As illustrated in FIGS. 3A to 3B, the connection method and/or the connection structure of the second connection portion 182A of the base plate 180 and the third connection portion 143A of the third bracket 140 are the same as or similar to the connection method and/or the connection structure of the first connection portion 181A and the third connection portion 133A of the second bracket 130, and they will not be repeated here. In addition, the connection method and/or the connection structure of the second connection portion 182B of the base plate 180 and the third connection portion 143B of the third bracket 140 are the same as or similar to the connection method and/or the connection structure of the second connection portion 182A of the base plate 180 and the third connection portion 143A of the third bracket 140, and they will not be repeated here.

As illustrated in FIGS. 3A to 3B and 4D, taking the third connection portion 183A as an example, the third connection portion 183A has a concavity 183Aa, and the sixth connection portion 126A of the first bracket 120 is, for example, a pivotal shaft, which may be connected to the concavity 183Aa. The sixth connection portion 126A may rotate in the concavity 183Aa and may slide up and down. The connection method and/or the connection structure of the third connection portion 183B of the base plate 180 and the sixth connection portion 126B of the first bracket 120 are the same as or similar to the connection method and/or the connection structure of the third connection portion 183A of the base plate 180 and the sixth connection portion 126A of the first bracket 120, and they will not be repeated here.

As illustrated in FIGS. 3A to 3B, the connection method and/or the connection structure of the fourth connection portion 184A of the base plate 180 and the seventh connection portion 127A of the first bracket 120 are the same as or similar to the connection method and/or the connection structure of the third connection portion 183A and the sixth connection portion 126A of the first bracket 120, and they will not be repeated here. In addition, the connection method and/or the connection structure of the fourth connection portion 184B of the base plate 180 and the seventh connection portion 127B of the first bracket 120 is the same as or similar to the connection method and/or the connection structure of the fourth connection portion 184A and the seventh connection portion 127A, and they will not be repeated here.

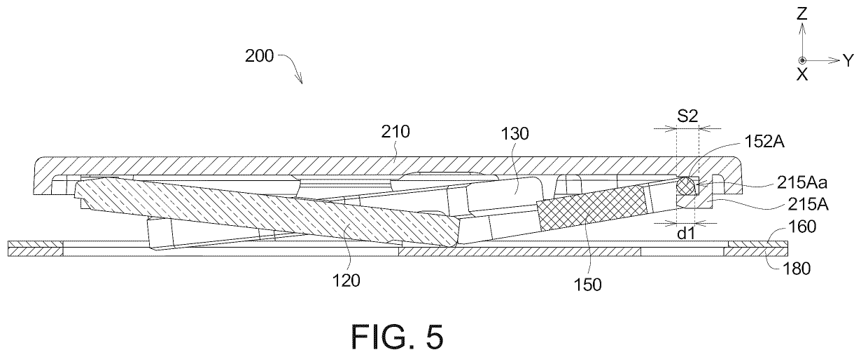

Referring to FIG. 5, FIG. 5 is a schematic diagram of a cross-sectional view of a key structure 200 according to another embodiment of the present invention. The key structure 200 includes at least one keycap 210, at least one first bracket 120, at least one second bracket 130, at least one third bracket 140 (not illustrated in FIG. 5), at least one first support element 150, the circuit board 160, at least one elastic body 170 (not illustrated in FIG. 5) and the base plate 180.

As illustrated in FIG. 5, the first bracket 120, the second bracket 130 and the third bracket 140 may form the lifting mechanism, or the first bracket 120, the second bracket 130, the third bracket 140 and the first support element 150 may form the lifting mechanism. In an embodiment, one lifting mechanism, one keycap 210, and one elastic body 170 may form one key module, and the key structure 200 is, for example, a keyboard, which may include at least one key module. The aforementioned keyboard is, for example, an individual keyboard, or a built-in keyboard of an electronic product, wherein the electronic product is, for example, a notebook computer, a home appliance, and other electronic products that require input functions.

As illustrated in FIG. 5, the key structure 200 includes the technical features the same as or similar to that of the key structure 100, and at least one difference is that the keycap 210 has a different structure from the keycap 110. The keycap 210 includes the technical features the same as or similar to that of the keycap 110, and at least one difference is that the fifth connection portion 215A of the keycap 210 has a different structure from the fifth connection portion 115A of the keycap 110.

For example, as illustrated in FIG. 5, the fifth connection portion 215A has a concavity 215Aa, and the concavity 215Aa provides a sliding space S2 extending along the Y-axis. The second connection portion 152A of the first support element 150 is, for example, a pivotal shaft, which has an outer diameter d1 along the Y-axis. In an embodiment, the sliding space S2 is larger than the outer diameter d1, and accordingly it may provide a movable clearance so that the keycap 210 and the first support element 150 may move relative to each other with less effort (if the movable clearance is omitted, the keycap 210 and the first support element 150 will interfere excessively during relative movement).

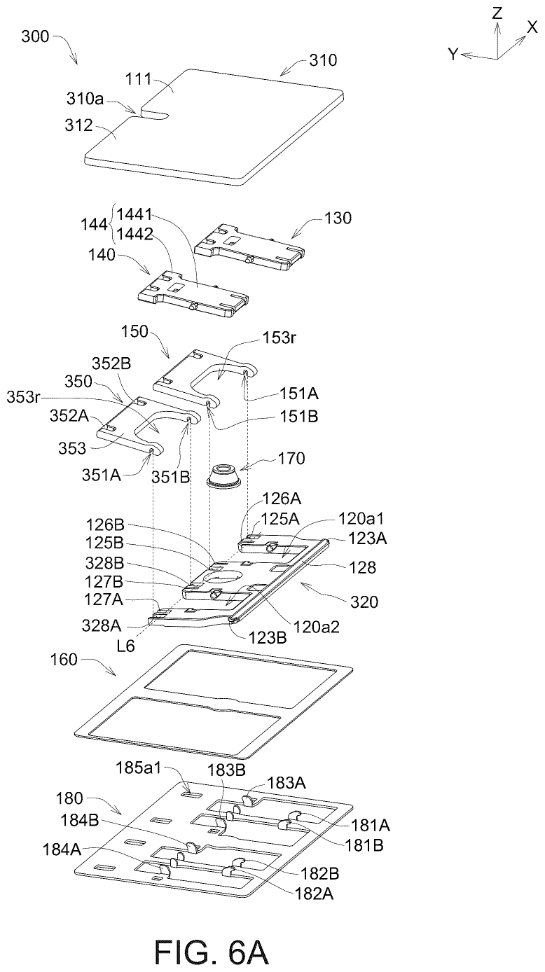

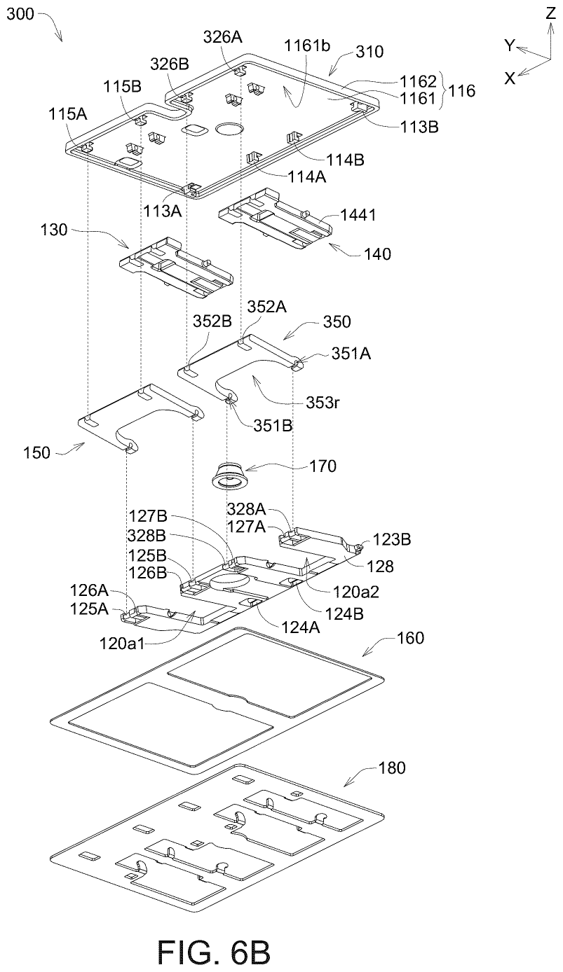

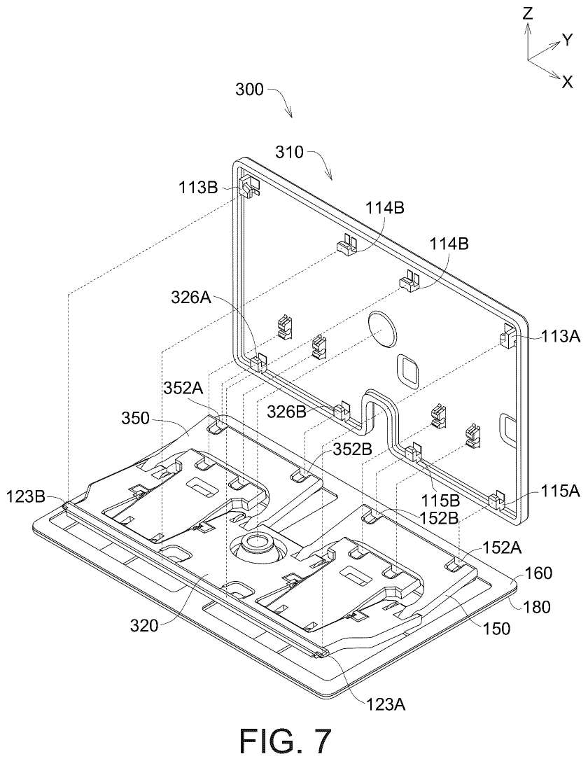

Referring to FIGS. 6A to 6B and 7, FIGS. 6A to 6B are schematic diagrams of exploded views of a key structure 300 according to another embodiment of the present invention at different viewing angles, and FIG. 7 is a schematic diagram of an assembly view of the key structure 300 in FIG. 6A (but the keycap 310 is disassembled). The key structure 300 includes at least one keycap 310, at least one first bracket 320, at least one second bracket 130, at least one third bracket 140, at least one first support element 150, at least one second support element 350, the circuit board 160, at least one elastic body 170 and the base plate 180.

As illustrated in FIGS. 6A to 6B and 7, the first bracket 320, the second bracket 130 and the third bracket 140 may form a lifting mechanism, or the first bracket 320, the second bracket 130, the third bracket 140, the first support element 150 and the second support element 350 may form a lifting mechanism. In an embodiment, one lifting mechanism, one keycap 310 and one elastic body 170 may form one key module. The key structure 300 is, for example, a keyboard, which may include at least one key module, which is disposed on the circuit board 160 and the base plate 180. In the present embodiment, the lifting mechanism is, for example, a scissor mechanism. The second bracket 130 and the third bracket 140 are partially surrounded by the first bracket 320, so the second bracket 130 and the third bracket 140 may be called “inner scissor brackets”, and the first bracket 320 may be called “outer scissor bracket”. In the present embodiment, the second bracket 130 is partially surrounded by the first support element 150, so the first support element 150 may also be called “outer scissor bracket”, and the third bracket 140 is partially surrounded by the second support element 350, so the second support element 350 may also be called “outer scissor bracket”. In addition, the aforementioned keyboard is, for example, an individual keyboard, or a built-in keyboard of an electronic product, wherein the electronic product is, for example, a notebook computer, a home appliance, or other electronic product that requires input function.

As illustrated in FIGS. 6A to 6B and 7, the key structure 300 includes technical features the same as or similar to that of the key structure 100, and at least one difference is that the key structure 300 further includes a second support element 350, and the first bracket 320 has a different structure from the aforementioned first bracket 120, and the keycap 310 has a different structure from the aforementioned keycap 110.

As illustrated in FIGS. 6A to 6B and 7, the keycap 310 includes protruding areas 111 and 312, wherein the first support element 150 overlaps with the protruding area 111 of the keycap 110 along the movement direction (e.g., along the Z-axis) of the keycap 110, and the second support element 350 overlaps with the protruding area 312 of the keycap 110 along the movement direction (e.g., along the Z-axis) of the keycap 310, and it thus may support the protruding areas 111 and 312 of the keycap 110 and increase the stability of the keycap 110 when the keycap 310 is pressed (the protruding areas 111 and 312 of the keycap 310 will be suspended in lack of the support of the first support element 150 and the second support element 350). In addition, there is a notch 310a between the protruding area 111 and the protruding area 312 of the keycap 310, and the notch 310a corresponds to an interval between the first support element 150 and the second support element 350, or the notch 310a and the support element (for example, the first support element 150 and/or the second support element 350) do not overlap at all along the movement direction (for example, the Z-axis direction) of the keycap 310, and/or the notch 310a and the bracket (for example, the first bracket 320, the second bracket 130 and/or the third bracket 140) do not overlap at all along the movement direction (for example, the Z-axis direction) of the keycap 310, that is, the first support element 150, the second support element 350, the first bracket 320, the second bracket 130 and/or the third bracket 140 do not exposed from the notch 110a (viewed in a top direction).

As illustrated in FIGS. 6A to 6B and 7, the keycap 310 is connected to the second bracket 130, the third bracket 140, the first support element 150 and the second support element 350. The features of the keycap 310 being connected to the second bracket 130, the third bracket 140 and the first support element 150 have been described above and they will not be repeated here. Compared with the aforementioned keycap 110, the keycap 310 further includes a plurality of sixth connection portions 326A and 326B and the sixth connection portions 326A and 326B are connected to the lower surface 1161b of the top plate 1161. In addition, the sixth connection portion 326A may be similar to or the same as the fifth connection portion 115A in structure. The sixth connection portion 326A may be similar to or the same as the sixth connection portion 326B in structure.

As illustrated in FIGS. 6A to 6B and 7, the first bracket 320 may connect the keycap 310, the second bracket 130, the third bracket 140, the first support element 150, the second support element 350 and the base plate 180. The features of the first bracket 320 connected to the keycap 310, the second bracket 130, the third bracket 140, the first support element 150 and the base plate 180 have been described above and they will not be repeated here. Compared with the first bracket 120 as described above, the first bracket 320 further includes a plurality of eighth connection portions 328A and 328B, and the eighth connection portion 328A and 328B are, for example, pivotal shafts, which is disposed on the first bracket body 128.

As illustrated in FIGS. 6A to 6B and 7, the first support element 150 and the second support element 350 are arranged along the second direction (for example, the Y-axis direction). The second support element 350 connects the first bracket 130 with the keycap 310, and the second support element 350 is disposed corresponding to the third bracket 140. The second support element 350 includes a plurality of first connection portions 351A and 351B, a plurality of second connection portions 352A and 352B and a support element body 353. The first connection portions 351A and 351B and the second connection portions 352A and 352B may be disposed on the support body 353. The first connection portions 351A and 351B are, for example, pivotal holes, and the second connection portions 352A and 352B are, for example, pivotal shafts. The support body 353 has a concavity 353r, and the third bracket 140 may be partially located in the concavity 353r after the second support 350 and the third bracket 140 are assembled. For example, the second portion 1442 of the third bracket 140 may be at least partially located in the concavity 353r. The concavity 153r of the first support 150 corresponds to a portion of the second bracket 130 in position, and the concavity 353r of the second support 350 corresponds to a portion of the third bracket 140 in position. In an embodiment, the second support 350 and the first support 150 may be the same or similar in structure.

In addition, the first connection portion 351A is similar to or the same as the first connection portion 351B in structure, and the second connection portion 352A is similar to or the same as the second connection portion 352B in structure. In addition, the first connection portion 351A of the second support element 350 is similar to or the same as the first connection portion 151A of the first support element 150 in structure, and the second connection portion 352A of the second support element 350 is similar to or the same as the second connection portion 152A of the first support element 150 in structure, and they will not be repeated here.

As illustrated in FIGS. 6A to 6B and 7, the fifth connection portions 125A and 125B and the eighth connection portions 328A and 328B of the first bracket 320 are arranged in a straight line L6. The first support element 150 and the second support element 350 are connected in the same straight line in the first bracket 320, and such a coaxial connection may reduce the complexity of the mechanism design.

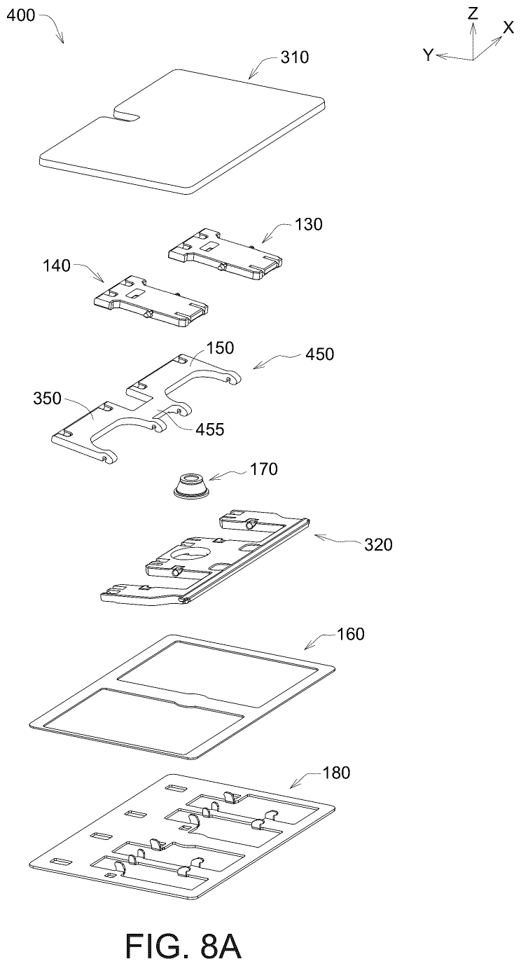

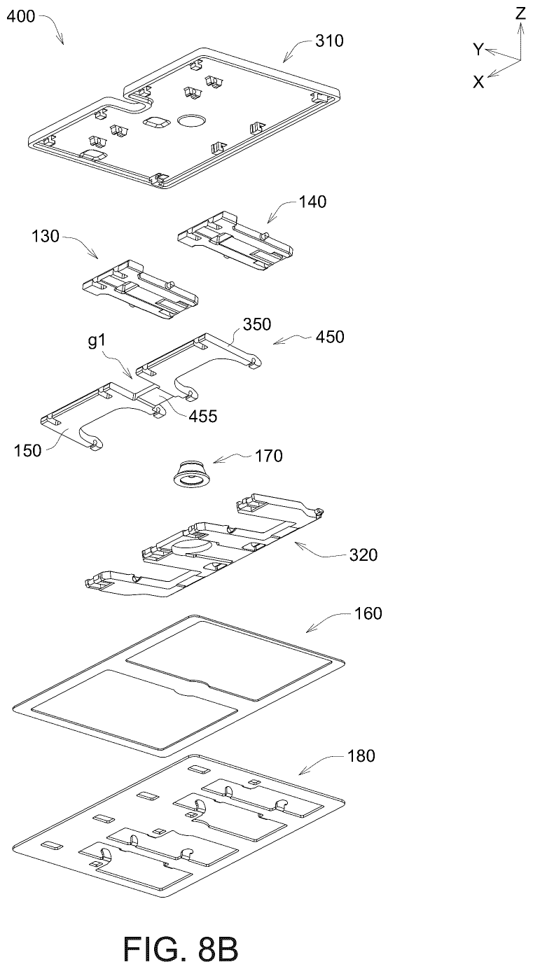

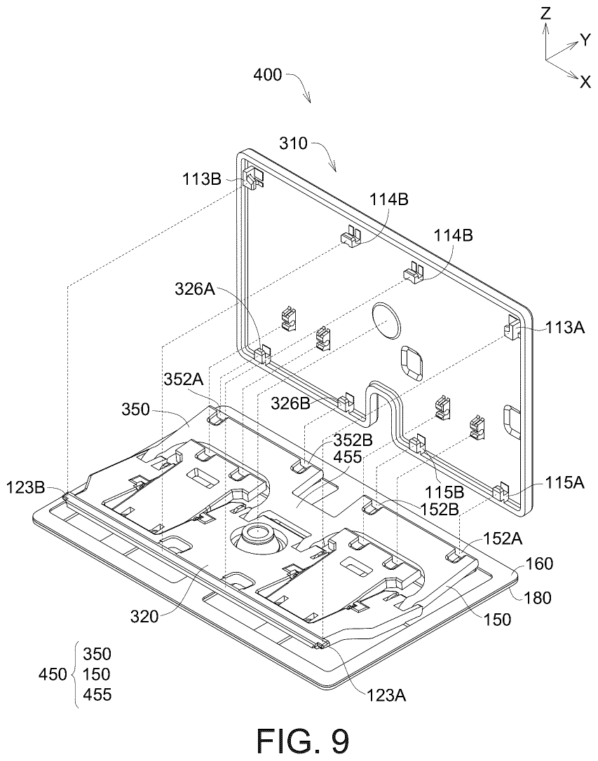

Referring to FIGS. 8A to 8B and 9, FIGS. 8A to 8B are schematic diagrams of exploded views of a key structure 400 according to another embodiment of the present invention at different viewing angles, and FIG. 9 is a schematic diagram of an assembly view of the key structure 400 in FIG. 8A (but the keycap 310 is disassembled). The key structure 400 includes at least one keycap 310, at least one first bracket 320, at least one second bracket 130, at least one third bracket 140, at least one first support element 150, at least one second support element 350, at least one connecting element 455, the circuit board 160, at least one elastic body 170 and the base plate 180.

As illustrated in FIGS. 8A to 8B and 9, the key structure 400 includes technical features the same as or similar to that of the key structure 300, and at least one difference is that the key structure 400 further includes the connecting element 455. The connecting element 455 may connect the first support element 150 with the second support element 350. After the connection, the connecting element 455, the first support element 150 and the second support element 350 become an integrated support module 450. In addition, there is a gap g1 between the first support element 150 and the second support element 350, and the gap g1 is disposed corresponding to the connecting element 455. The support module 450 may be formed by, for example, an injection molding technology. In terms of material, the connecting element 455, the first support element 150 and the second support element 350 may be formed of the same material, such as plastic.

As illustrated in FIGS. 8A to 8B and 9, the first bracket 320, the second bracket 130 and the third bracket 140 may form a lifting mechanism, or the first bracket 320, the second bracket 130, the third bracket 140 and the support module 450 may form a lifting mechanism. In an embodiment, one lifting mechanism, one keycap 310 and one elastic body 170 may form one key module. The key structure 400 is, for example, a keyboard, which may include at least one key module which is disposed on the circuit board 160 and the base plate 180. In the present embodiment, the lifting mechanism is, for example, a scissor mechanism. The second bracket 130 and the third bracket 140 are partially surrounded by the first bracket 320, so the second bracket 130 and the third bracket 140 may be called “inner scissor brackets”, and the first bracket 320 may be called “outer scissor bracket”. In the present embodiment, the second bracket 130 is partially surrounded by the support module 450, so the support module 450 may also be called “outer scissor bracket”. In addition, the aforementioned keyboard is, for example, an individual keyboard, or a built-in keyboard of an electronic product, wherein the electronic product is, for example, a notebook computer, a home appliance, and other electronic products that require input functions.

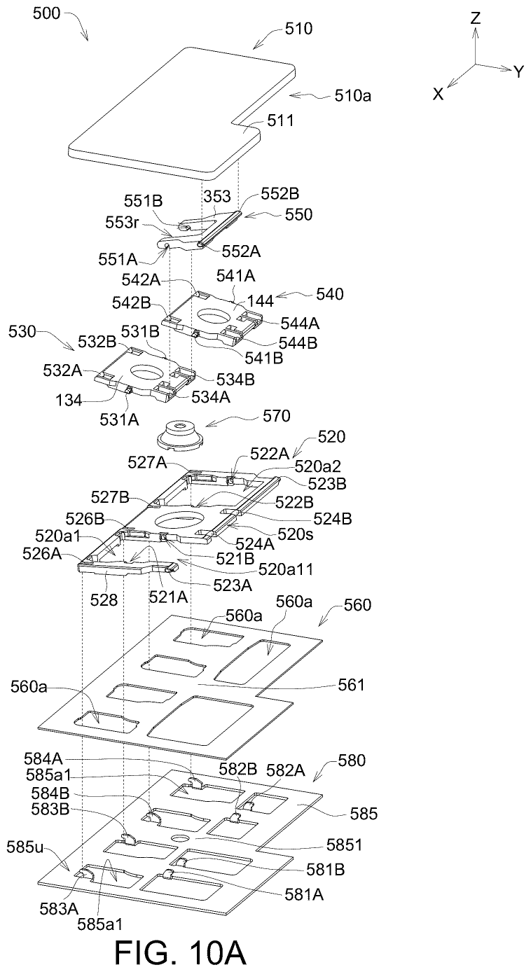

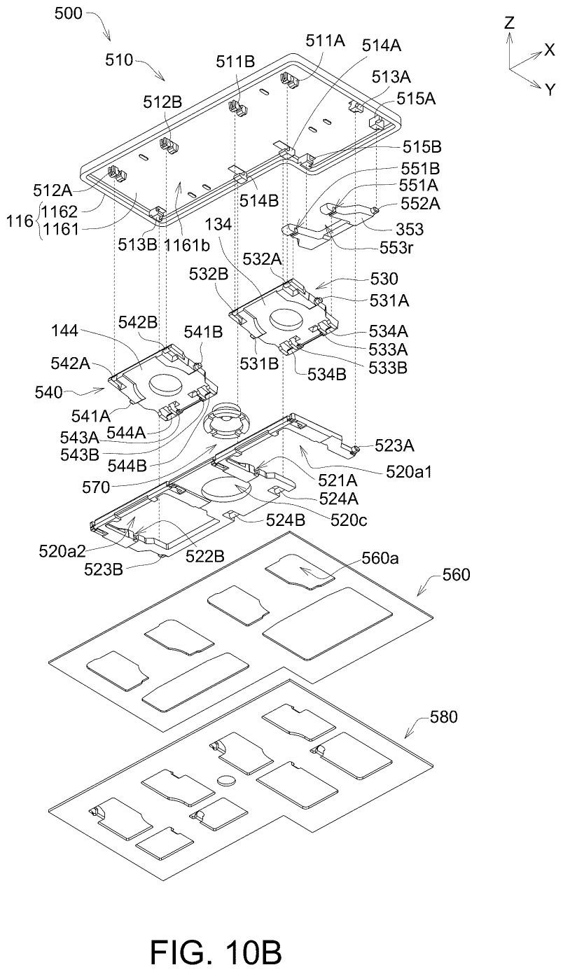

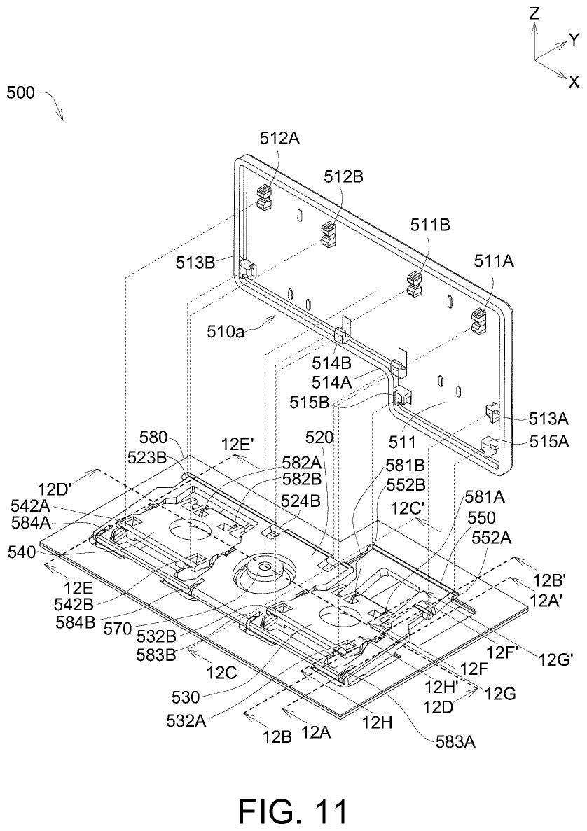

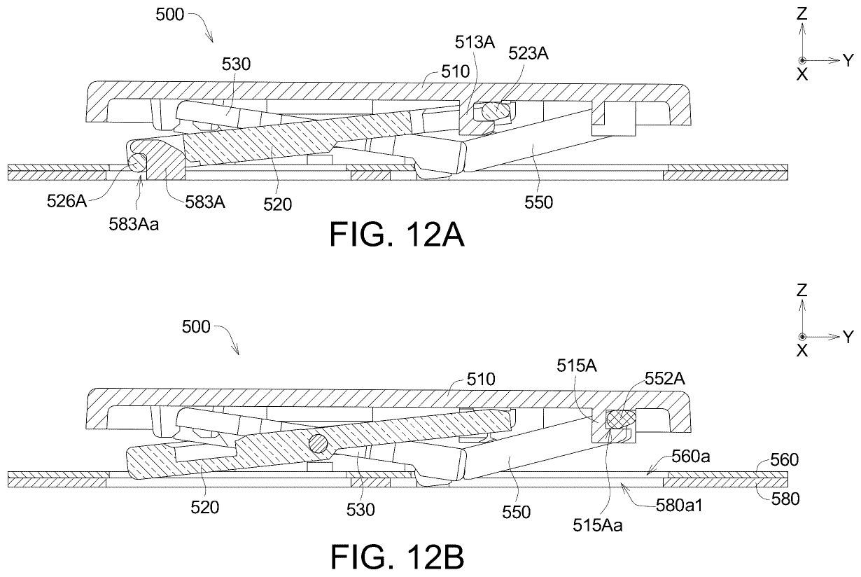

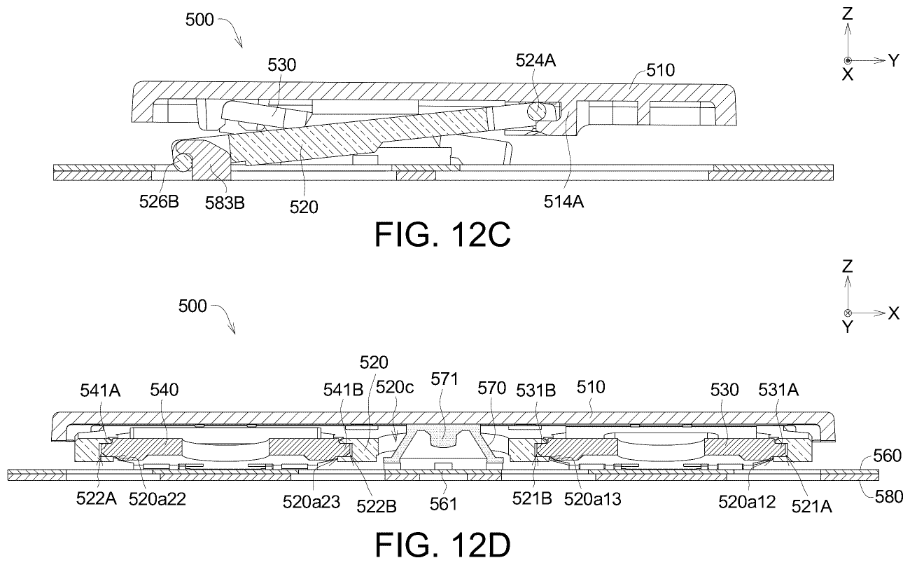

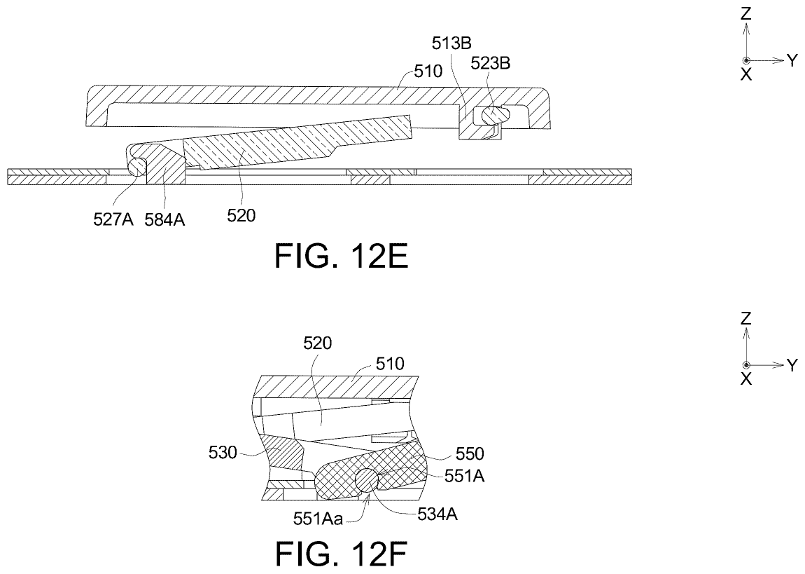

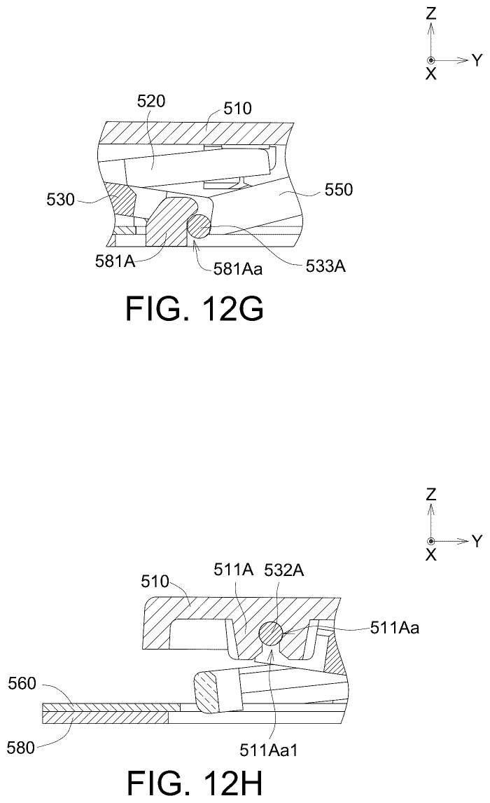

Referring to FIGS. 10A to 12H, FIGS. 10A and 10B are schematic diagrams of a key structure 500 according to an embodiment of the present invention at different viewing angles, FIG. 11 is an assembly schematic diagram of the key structure 500 in FIG. 10A (but the keycap 510 is disassembled), FIG. 12A is a schematic diagram of a cross-sectional view of the key structure 500 in FIG. 11 along a direction 12A-12A′ (including the assembled keycap 510), FIG. 12B is a schematic diagram of a cross-sectional view of the key structure 500 in FIG. 11 along a direction 12B-12B′ (including the assembled keycap 510), FIG. 12C is a schematic diagram of a cross-sectional view of the key structure 500 in FIG. 11 along a direction 12C-12C′ (including the assembled keycap 510), FIG. 12D is a schematic diagram of a cross-sectional view of the key structure 500 in FIG. 11 along a direction 12D-12D′ (including the assembled keycap 510), FIG. 12E is a schematic diagram of a cross-sectional view of the key structure 500 in FIG. 11 along a direction 12E-12E′ (including the assembled keycap 510), FIG. 12F is a schematic diagram of a cross-sectional view of the key structure 500 in FIG. 11 along a direction 12F-12F′ (including the assembled keycap 510), FIG. 12G is a schematic diagram of a cross-sectional view of the key structure 500 in FIG. 11 along a direction 12G-12G′ (including the assembled keycap 510), and FIG. 12H is a schematic diagram of a cross-sectional view of the key structure 500 in FIG. 11 along a direction 12H-12H′ (including the assembled keycap 510).

As illustrated in FIGS. 10A to 10B and 11, the key structure 500 includes at least one keycap 510, at least one first bracket 520, at least one second bracket 530, at least one third bracket 540, at least one first support element 550, a circuit board 560, at least one elastic body 570 and a base plate 580.

As illustrated in FIGS. 10A to 10B and 11, the first bracket 520, the second bracket 530 and the third bracket 540 may form a lifting mechanism, or the first bracket 520, the second bracket 530, the third bracket 540 and the first support element 550 may form a lifting mechanism. In an embodiment, one lifting mechanism, one keycap 510 and one elastic body 570 may form one key module. The key structure 500 is, for example, a keyboard, which may include at least one key module. In an embodiment, the lifting mechanism is, for example, a scissor mechanism. The second bracket 530 and the third bracket 540 are partially surrounded by the first bracket 520, so the second bracket 530 and the third bracket 540 may be called “inner scissor brackets”, and the first bracket 520 may be called “outer scissor bracket”. In the present embodiment, the second bracket 530 is partially surrounded by the first support element 550, so the first support element 550 may also be called “outer scissor bracket”. In addition, the aforementioned keyboard is, for example, an individual keyboard, or a built-in keyboard of an electronic product, wherein the electronic product is, for example, a notebook computer, a home appliance, or other electronic product that requires input functions.

As illustrated in FIGS. 10A to 10B and 11, the key structure 500 includes technical features the same as or similar to the aforementioned key structure 100, and at least one difference is that the first support element 550 of the key structure 500 of the embodiment of the invention is connected to the second bracket 530.

As illustrated in FIG. 11, the first bracket 520, the second bracket 530 and the third bracket 540 may form a lifting mechanism, or the first bracket 520, the second bracket 530, the third bracket 540 and the first support element 550 may form a lifting mechanism. In an embodiment, one lifting mechanism, one keycap 510 and one elastic body 570 may form one key module, and the key structure 500 may be, for example, a keyboard, which may include at least one key module which is disposed on the circuit board 560 and the base plate 580. In an embodiment, the lifting mechanism is, for example, a scissor mechanism. The second bracket 530 and the third bracket 540 may be at least partially surrounded by the first bracket 520, so the second bracket 530 and the third bracket 540 may be referred to as “inner scissor brackets”, and the first bracket 520 may be referred to as “outer scissor bracket”.

As illustrated in FIGS. 10A to 10B and 11, the first bracket 520 is connected to the keycap 510 and has a lateral surface 520s, a first mounting portion 520a1 and a second mounting portion 520a2, wherein the first mounting portion 520a1 exposes a first opening 520a11 from the lateral surface 520s. The second bracket 530 is connected to the first bracket 520 and is disposed at the first mounting portion 520a1. The third bracket 140 is connected to the first bracket 520 and is disposed at the second mounting portion 520a2. In the present embodiment, the first support element 550 is connected to the second bracket 530 through the first opening 520a11 and protrudes relative to the lateral surface 520s.

The first support element 550 protrudes from the first bracket 520, so it may support the corresponding portion of the keycap 110. As a result, the keycap 510 may be designed into different shapes (or “special-shaped keycap”). For example, the keycap 510 includes a protruding area 511, and the first support element 550 may be disposed adjacent to the protruding area 511 of the keycap 510 for being adjacent to and supporting the protruding area 511 of the keycap 510. In addition, the keycap 510 has a notch 510a, and the notch 510a and the first support element 550 do not overlap along the movement direction (for example, the Z-axis direction) of the keycap 510.

Compared with the aforementioned key structure 100, the second bracket 530 of the present embodiment is retracted relative to the first opening 520a11, that is, the second bracket 530 of the key structure 500 of the present embodiment does not protrude relative to the first opening 520a21. Viewed in a top view (looking in the −Z-axis direction), the third bracket 540 may be entirely located in the second mounting portion 520a2. In another embodiment, depending on the actual situation (for example, matching the shape of the keycap 510), the second bracket 530 may protrude relative to the first opening 520a11, which is similar to the second bracket 130 of the aforementioned key structure 100.

As illustrated in FIG. 10B, the keycap 510 includes a plurality of first connection portions 511A and 511B, a plurality of second connection portions 512A and 512B, a plurality of third connection portions 513A and 513B, a plurality of fourth connection portions 514A and 514B, a plurality of fifth connection portions 515A and 515B and a cap body 116. The cap body 116 includes the top plate 1161 and the lateral plate 1162, wherein the lateral plate 1162 is connected to the edge of the top plate 1161. The first connection portions 511A and 511B, the second connection portions 512A and 512B, the third connection portions 513A and 513B, and the fourth connection portions 514A and 514B are connected to the lower surface 1161b of the top plate 1161.

As illustrated in FIG. 10B, the first connection portion 511A is the same as or similar to the first connection portion 511B in structure, the second connection portion 512A is the same as or similar to the second connection portion 512B in structure, the third connection portion 513A is the same as or similar to the third connection portion 513B in structure, the fourth connection portion 514A is the same as or similar to the fourth connection portion 514B in structure, and the fifth connection portion 515A is the same as or similar to the fifth connection portion 515B in structure.

As illustrated in FIGS. 10A to 10B and 11, the keycap 510 may be connected to the first bracket 520, the second bracket 530, the third bracket 540 and the first support element 550. For example, the first connection portions 511A and 511B may be connected to the second bracket 530, the second connection portions 512A and 512B may be connected to the third bracket 540, the third connection portions 513A and 513B and the fourth connection portions 514A and 514B may be connected to the first bracket 520, and the fifth connection portions 515A and 515B may be connected to the first support element 550.

As illustrated in FIGS. 10A to 10B and 11, the first bracket 520 may connect the keycap 510, the second bracket 530, the third bracket 540, the first support element 550 and the base plate 580. For example, the first bracket 520 includes a plurality of first connection portions 521A and 521B, a plurality of second connection portions 522A and 522B, a plurality of third connection portions 523A and 523B, a plurality of fourth connection portions 524A and 524B, a plurality of sixth connection portions 526A and 526B, a plurality of seventh connection portions 527A and 527B and a first bracket body 528.

As illustrated in FIGS. 10A and 10B, the first connection portion 521A is the same as of or similar to the first connection portion 521B in structure, the second connection portion 522A is the same as or similar to the second connection portion 522B in structure, the third connection portion 523A is the same as or similar to the third connection portion 523B in structure, the fourth connection portion 524A is the same as or similar to the fourth connection portion 524B in structure, the sixth connection portion 526A is the same as or similar to the sixth connection portion 526B in structure, and the seventh connection portion 527A is the same as or similar to the seventh connection portion 527B in structure.

As illustrated in FIGS. 10A to 11 and 12D, the first connection portions 521A and 521B and the second connection portions 522A and 522B are, for example, pivotal holes, which are disposed on the first bracket body 528, and the third connection portions 523A and 523B, the fourth connection portions 524A and 524B, the sixth connection portions 526A and 526B, and the seventh connection portions 527A and 527B are, for example, pivotal shafts, which may be connected to the first bracket body 528. In an embodiment, the third connection portions 523A and 523B, the fourth connection portions 524A and 524B, the sixth connection portions 526A and 526B, the seventh connection portions 527A and 527B and the first bracket body 528 form, for example, an integrally formed structure. For example, the integrated first bracket 520 is formed by the injection molding technology. In terms of material, the first bracket 520 is, for example, made of plastic.

As illustrated in FIGS. 10A to 10B and 11, the first connection portions 521A and 521B of the first bracket 520 may be connected to the second bracket 530, the second connection portions 522A and 522B of the first bracket 520 may be connected to the third bracket 540, the third connection portions 523A and 523B and the fourth connection portions 524A and 524B of the first bracket 520 may be connected to the keycap 510, and the sixth connection portions 526A and 526B and the seventh connection portions 527A and 527B of the first bracket 520 may be connected to the base plate 580.

As illustrated in FIG. 12D, the first mounting portion 520a1 of the first bracket 520 has a first inner lateral surface 520a12 and a second inner lateral surface 520a13 opposite to the first inner lateral surface 520a12, the first connection portion 521A is recessed relative to the first inner lateral surface 520a12, and the first connection portion 521B is recessed relative to the second inner lateral surface 520a13. Similarly, the second mounting portion 520a2 of the first bracket 520 has a third inner lateral surface 520a22 and a fourth inner lateral surface 520a23 opposite to the third inner lateral surface 520a22, the second connection portion 522A is recessed relative to the third inner lateral surface 520a22, and the second connection portion 522B is recessed relative to the fourth inner lateral surface 520a23.

As illustrated in FIGS. 10A to 10B, 11 and 12A, the third connection portions 523A and 523B of the first bracket 520 are respectively connected to the third connection portions 513A and 513B of the keycap 510, and the fourth connection portions 524A and 524B of the first bracket 520 are respectively connected to the fourth connection portions 514A and 514B of the keycap 510. Similar to the aforementioned first bracket 120, the third connection portions 523A and 523B and the fourth connection portions 524A and 524B of the first bracket 520 of the present embodiment may be arranged in a straight line (e.g., substantially parallel to the X-axis), and the third connection portions 513A and 513B and the fourth connection portions 514A and 514B of the keycap 510 are also arranged in a straight line (e.g., substantially parallel to the X-axis) correspondingly. In the present embodiment, a plurality of the connection portions of the keycap 510 (e.g., the third connection portions 513A and 513B and the fourth connection portions 514A and 514B) are coaxially connected with a plurality of the connection portions of the first bracket 520 (e.g., the third connection portions 523A and 523B and the fourth connection portions 524A and 524B), and accordingly it may reduce the complexity of the mechanism design. In addition, a plurality of the connection portions of the keycap 510 (for example, the third connection portion 513B and the fourth connection portions 514A and 514B) are arranged adjacent to a side of the keycap 510 to provide an edge support effect, and it accordingly may increase the stability of the keycap 510 when the keycap 51 is pressed. In addition, the fourth connection portions 524A and 524B of the first bracket 520 are located between the third connection portion 523A and the third connection portion 523B, and it accordingly may provide more support points (for example, four) and increase the stability of the first bracket 520 supporting the keycap 510. In another embodiment, the number of the fourth connection portions of the first bracket 520 may be more than two or one, and the number of the fourth connection portions of the keycap 510 may be changed accordingly.

As illustrated in FIGS. 10B and 12D, the first bracket 520 has a through hole 520c, and the through hole 520c allows the elastic body 570 to pass through and press against the keycap 510.

As illustrated in FIGS. 10A to 10B and 11, the second bracket 530 includes a plurality of first connection portions 531A and 531B, a plurality of second connection portions 532A and 532B, a plurality of third connection portions 533A and 533B, a second bracket body 134 and a plurality of fourth connection portions 534A and 534B, wherein the first connection portions 531A and 531B, the second connection portions 532A and 532B, the third connection portions 533A and 533B and the fourth connection portions 534A and 534B are, for example, pivotal shafts that may be connected to the second bracket body 134.

The first connection portion 531A is the same as or similar to the first connection portion 531B in structure, the second connection portion 532A is the same as or similar to the second connection portion 532B in structure, the third connection portion 533A is the same as or similar to the third connection portion 533B in structure, and the fourth connection portion 534A is the same as or similar to the fourth connection portion 534B in structure.

As illustrated in FIG. 11, viewed in a top view (e.g., looking in the −Z axial direction), the second bracket 530 is surrounded by the first bracket 520 and the first support bracket 550.

As illustrated in FIGS. 10A to 10B, 11 and 12D, the first connection portions 531A and 531B of the second bracket 530 may be connected to the first bracket 520. For example, the first connection portions 521A and 521B of the first bracket 520 are, for example, pivotal holes, and the first connection portions 531A and 531B of the second bracket 530 are, for example, pivotal shafts, and the first connection portions 531A and 531B may be connected to the first connection portions 521A and 521B of the first bracket 520, respectively.

As illustrated in FIGS. 10A to 10B, 11 and 12H, the second connection portions 532A and 532B (e.g., pivotal shafts) of the second bracket 530 may be connected to the first connection portions 511A and 511B (e.g., having pivotal holes) of the keycap 510 respectively. For example, taking the first connection portion 511A as an example, the first connection portion 511A has a pivotal hole 511Aa, and the second connection portion 532A of the second bracket 530 is connected to the pivotal hole 511Aa of the first connection portion 511A. An inner diameter of the pivotal hole 511Aa is substantially equal to an outer diameter of the second connection portion 532A, so the relative movement between the second connection portion 532A and the pivotal hole 511Aa is pure rotation without sliding. The first connection portion 511A further has an opening 511Aa1, and the opening 511Aa1 is connected to the pivotal hole 511Aa. An inner diameter of the opening 511Aa1 is smaller than an inner diameter of the pivotal hole 511Aa, so that the second connection portion 532A may be prevented from easily detaching from the pivotal hole 511Aa.

The connection method and/or the connection structure of the second connection portion 532B of the second bracket 530 and the first connection portion 511B of the keycap 510 are the same as or similar to the connection method and/or the connection structure of the second connection portion 532A of the second bracket 530 and the first connection portion 511A of the keycap 510, and they will not be repeated here.

As illustrated in FIGS. 10A to 10B and 11, the third bracket 540 includes a plurality of first connection portions 541A and 541B, a plurality of second connection portions 542A and 542B, a plurality of third connection portions 543A and 543B, a third bracket body 144 and a plurality of fourth connection portions 544A and 544B, wherein the first connection portions 541A and 541B, the second connection portions 542A and 542B, the third connection portions 543A and 543B and the fourth connection portions 544A and 544B are, for example, pivotal shafts, which may be connected to the third bracket body 144.

The first connection portion 541A is the same as or similar to the first connection portion 541B in structure, the second connection portion 542A is the same as or similar to the second connection portion 542B in structure, and the third connection portion 543A is the same as or similar to the third connection portion 543B in structure, and the fourth connection portion 544A is the same as or similar to the fourth connection portion 544B in structure.

As illustrated in FIGS. 10A to 10B and 11, in the present embodiment, the third bracket 540 is the same as or similar to the second bracket 530 in structure. Viewed in a top view (for example, looking in the −Z axial direction), the third bracket 540 is completely surrounded by the first bracket 520.

As illustrated in FIGS. 10A to 10B and 12D, the first connection portions 541A and 541B of the third bracket 540 may be connected to the first bracket 520. For example, the second connection portions 522A and 522B of the first bracket 520 are, for example, pivotal holes, and the first connection portions 541A and 541B of the third bracket 540 are, for example, pivot shafts, and the first connection portions 541A and 541B may be connected to the second connection portions 522A and 522B of the first bracket 520 respectively.

As illustrated in FIGS. 10A and 10B, the second connection portions 542A and 542B (e.g., pivotal shafts) of the third bracket 540 may be respectively connected to the second connection portions 512A and 512B (e.g., having pivotal holes) of the keycap 510. The connection method and/or the connection structure of the second connection portion 542A of the third bracket 540 and the second connection portion 512A of the keycap 510 are the same as or similar to the connection method and/or the connection structure of the second connection portion 532A and the first connection portion 511A of the keycap 510 (as illustrated in FIG. 12D), and they are not repeated here. In addition, the connection method and/or the connection structure of the second connection portion 542B of the third bracket 540 and the second connection portion 512B of the keycap 510 are the same as or similar to the connection method and/or the connection structure of the second connection portion 542A of the third bracket 540 and the second connection portion 512A of the keycap 510, and they are not repeated here.

As illustrated in FIGS. 10A to 10B and 11, the first support element 550 includes a plurality of first connection portions 551A and 551B, a plurality of second connection portions 552A and 552B and a support element body 553. The first connection portions 551A and 551B and the second connection portions 552A and 552B may be disposed on the support element body 553. The first connection portion 551A is similar to or the same as the first connection portion 551B in structure, and the second connection portion 152A is similar to or the same as the second connection portion 152B in structure.

As illustrated in FIGS. 10A to 10B and 11, the first connection portions 551A and 551B are, for example, pivotal holes, and the second connection portions 552A and 552B are, for example, pivot shafts. The support element body 553 has a concavity 553r. Viewed in a top view of FIG. 11 (for example, looking in the −Z axial direction), after the first support element 550 and the first bracket 520 are assembled, the first support element 550 may be partially located in the first mounting portion 520a1 of the first bracket 520, and the second bracket 530 may be partially located in the concavity 553r. The first support element 550 may be connected to the second bracket 530 through the first opening 520a11 of the first mounting portion 520a1.

As illustrated in FIGS. 10A to 10B, 11 and 12F, in the present embodiment, the first support element 550 is connected to the second bracket 530. For example, the first connection portions 551A and 551B may be connected to the fourth connection portions 534A and 534B of the second bracket 530 respectively. Taking the first connection portion 551A as an example, the first connection portion 551A has a pivotal hole 551Aa, and the fourth connection portion 534A is, for example, a pivot shaft, and the fourth connection portion 534A is connected to the pivotal hole 551Aa. An inner diameter of the pivotal hole 551Aa is substantially equal to an outer diameter of the fourth connection portion 534A, so the relative movement between the fourth connection portion 534A and the pivotal hole 551Aa is pure rotation without sliding. The connection method and/or the connection structure of the first connection portion 551B of the first support element 550 and the fourth connection portion 534B of the second bracket 530 are the same as or similar to the connection method and/or the connection structure of the first connection portion 551A and the fourth connection portion 534A of the second bracket 530, and they will not be repeated here.

In the present embodiment, the first support element 550 and the second bracket 530 are buckled, and accordingly it may help to improve assembly and reduce the complexity of the structure and simplify the assembly process.

As illustrated in FIGS. 10B, 11 and 12B, the second connection portions 552A and 552B of the first support element 550 are, for example, pivotal shafts, which may be connected to the fifth connection portions 515A and 515B of the keycap 510 respectively. The second connection portion 552A is, for example, a pivotal shaft, and the fifth connection portion 515A has a pivotal hole 515Aa. An inner diameter of the pivotal hole 515Aa may be greater than an outer diameter of the pivotal shaft (for example, the second connection portion 552A), so that the second connection portion 552A may be slidably disposed in the pivotal hole 515Aa, and accordingly it allows the keycap 510 and the first support element 550 to move relative to each other with less effort (if the movement allowance is omitted, the keycap 110 and the first support element 550 will interfere excessively during relative movement).

The connection method and/or the connection structure of the second connection portion 552B of the first support element 550 and the fifth connection portion 515B of the keycap 510 are the same as or similar to the connection method and/or the connection structure of the second connection portion 552A of the first support element 550 and the fifth connection portion 515A of the keycap 510, and they will not be repeated here.

As illustrated in FIGS. 10A to 10B and 11, the circuit board 560 is, for example, a membrane switch circuit board. Although not illustrated, the circuit board 560 is a multilayer structure, which includes at least one first circuit and at least one second circuit, wherein the corresponding first circuit and second circuit may be selectively in contact or spaced from each other. The first trace and the second trace overlapping the elastic body 570 along the Z-axis form a switch, and a trigger signal may be generated when the switch is triggered. The circuit board 560 has at least one through hole 560a, and the through hole 560a may expose a plurality of the connection portions of the base plate 580 to allow the connection portions of the base plate 580 to be connected to corresponding elements. The through hole 560a may provide a collision-avoidance space. For example, as illustrated in FIG. 12B, the fifth connection portion 515A overlaps with the through hole 560a along the movement direction (e.g., Z-axis) of the keycap 510. As a result, when the key structure 500 is in the pressed state, the fifth connection portion 515A may be partially located in the through hole 560a to avoid interference with the physical material of the circuit board 560, and accordingly it may avoid impact noise. In addition, the circuit board 560 includes at least one carrying portion 561, and the carrying portion 561 may receive the elastic body 570.

As illustrated in FIGS. 10A to 10B, 11 and 12D, the elastic body 570 may be disposed on the carrying portion 561 of the circuit board 560. When the elastic body 570 is deformed (for example, the keycap 510 is pressed), the triggering portion 571 of the elastic body 570 presses against the switch (not illustrated) in the carrying portion 561. When the switch is triggered, the triggering signal (not illustrated) may be transmitted to a processor (not illustrated), and the processor executes the corresponding function. In an embodiment, the elastic body 570 may be formed of rubber, but it may also be a spring.

As illustrated in FIGS. 10A to 10B and 11, the base plate 580 includes a plurality of first connection portions 581A and 581B, a plurality of second connection portions 582A and 582B, a plurality of third connection portions 583A and 583B, a plurality of fourth connection portions 584A and 584B and a base plate body 585. The first connection portion 581A is similar to or the same as the first connection portion 581B in structure, the second connection portion 582A is similar to or the same as the second connection portion 582B in structure, the third connection portion 583A is similar to or the same as the third connection portion 583B in structure, and the fourth connection portion 584A is similar to or the same as the fourth connection portion 584B in structure.

As illustrated in FIGS. 10A to 10B and 11, the base plate body 585 has a surface 585u, wherein the first connection portions 581A and 581B, the second connection portions 582A and 582B, the third connection portions 583A and 583B, and the fourth connection portions 584A and 584B may protrude relative to the surface 585u. In an embodiment, the first connection portions 581A and 581B, the second connection portions 582A and 582B, the third connection portions 583A and 583B, the fourth connection portions 584A and 584B and the base plate body 585 are formed, for example, an integrally formed structure. In terms of manufacturing process, the integrated base plate 580 may be formed by stamping and/or bending a plate. In terms of material, the base plate 580 may be formed of metal, but it may also be plastic.

As illustrated in FIGS. 10A to 10B and 11, the first connection portions 581A and 581B of the base plate 580 may be connected to the third connection portions 533A and 533B of the second bracket 530, the second connection portions 582A and 582B may be connected to the third connection portions 543A and 543B of the third bracket 540, and the third connection portions 583A and 583B and the fourth connection portions 584A and 584B may be connected to the first bracket 520.

As illustrated in FIGS. 10A to 10B and 11, in the present embodiment, the first connection portions 581A and 581B and the second connection portions 582A and 582B of the base plate 580 may be arranged in a straight line (e.g., substantially parallel to the X-axis), so that the third connection portions 533A and 533B of the second bracket 530 and the third connection portions 543A and 543B of the third bracket 540 may be connected to the base plate 580 along a straight line. In other words, the second bracket 530 and the third bracket 540 are connected in the same straight line of the base plate 580, and such a coaxial connection may reduce the complexity of the mechanism design. In addition, the third connection portions 583A and 583B and the fourth connection portions 584A and 584B of the base plate 580 may be arranged in a straight line (for example, substantially parallel to the X-axis), the sixth connection portions 526A and 526B and the seventh connection portions 527A and 527B of the first bracket 520 may be arranged in a straight line (for example, substantially parallel to the X-axis), and the first bracket 520 may be connected to the base plate 580 along a straight line. In other words, the first bracket 520 is connected to the same straight line of the base plate 580, and such a coaxial connection may reduce the complexity of the mechanism design.

As illustrated in FIGS. 10A and 12B, the base plate body 585 of the base plate 580 further has at least one through hole 585a1. The fifth connection portion 515A overlaps with the through hole 585a1 along the movement direction (for example, the Z-axis) of the keycap 510. Thus, when the key structure 500 is in the pressed state, the fifth connection portion 515A may be partially located in the through hole 585a1 for avoiding the interference with the physical material of the base plate 580, and accordingly it may avoid the impact noise.

As illustrated in FIGS. 10A to 10B and 12G, taking the first connection portion 581A as an example, the first connection portion 581A has a concavity 581Aa, and the third connection portion 533A of the second bracket 530 is, for example, a pivotal shaft, which may be connected to the concavity 581Aa. The concavity 581Aa provides a sliding space extending along the Z-axis, so that the third connection portion 533A may slide along the Z-axis in the concavity 581Aa. The connection method and/or the connection structure of the first connection portion 581B of the base plate 580 and the third connection portion 533B of the second bracket 530 are the same as or similar to the connection method and/or the connection structure of the first connection portion 581A of the base plate 580 and the third connection portion 533A of the second bracket 530, and they will not be repeated here.

As illustrated in FIGS. 10A to 10B, the connection method and/or the connection structure of the second connection portion 582A of the base plate 580 and the third connection portion 543A of the third bracket 540 are the same as or similar to the connection method and/or the connection structure of the first connection portion 581A and the third connection portion 533A of the second bracket 530, and they will not be repeated here. In addition, the connection method and/or the connection structure of the second connection portion 582B of the base plate 580 and the third connection portion 543B of the third bracket 540 are the same as or similar to the connection method and/or the connection structure of the second connection portion 582A of the base plate 580 and the third connection portion 543A of the third bracket 540, and they will not be repeated here.

As illustrated in FIGS. 10A to 10B and 12A, taking the third connection portion 583A as an example, the third connection portion 583A has a concavity 583Aa, and the sixth connection portion 526A of the first bracket 520 is, for example, a pivotal shaft, which may be connected to the concavity 583Aa. The sixth connection portion 526A may rotate in the concavity 583Aa and may slide up and down. The connection method and/or the connection structure between the third connection portion 583B of the base plate 580 and the sixth connection portion 526B of the first bracket 520 and the connection method and/or the connection structure between the third connection portion 583A of the base plate 580 of the key structure 100 and the sixth connection portion 526A of the first bracket 520, and they will not be repeated here.

As illustrated in FIGS. 10A to 10B and 12E, the connection method and/or the connection structure between the fourth connection portion 584A of the base plate 580 and the seventh connection portion 527A of the first bracket 520 is the same as or similar to the connection method and/or the connection structure between the third connection portion 583A and the sixth connection portion 526A of the first bracket 520 (as illustrated in FIG. 12A), and they are not repeated here. In addition, the connection method and/or the connection structure between the fourth connection portion 584B of the base plate 580 and the seventh connection portion 527B of the first bracket 520 is the same as or similar to the connection method and/or the connection structure between the fourth connection portion 584A and the seventh connection portion 527A, and they will not be repeated here.

In another embodiment, the key structure 500 may further include a second support element having the same or similar structure as the first support element 550. The second mounting portion 520a2 of the first bracket 520 exposes a second opening from the lateral surface 520s. As a result, the configuration relationship between the second support element and the first bracket 520 may be the same as or similar to the configuration relationship between the first support element 550 and the first bracket 520.

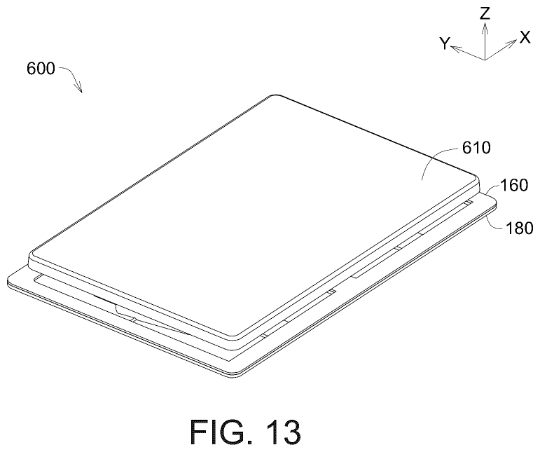

Referring to FIG. 13, FIG. 13 is a schematic diagram of a key structure 600 according to another embodiment of the invention. The key structure 600 includes at least one keycap 610, at least one first bracket 120 (not illustrated), at least one second bracket 130 (not illustrated), at least one third bracket 140 (not illustrated), at least one first support element 150 (not illustrated), the circuit board 160, at least one elastic body 170 (not illustrated) and the base plate 180.

The key structure 600 includes the structures the same as or similar to that of any of the aforementioned key structures 100 to 500, and at least one difference is that the keycap 610 does not include a protruding area or a notch feature. In an embodiment, the keycap 610 may be a general standard keycap, such as a single key or a multiple key. In addition, the keycaps of the key structures of other embodiments of the present invention may include features the same as or similar to that of the keycap 610, or may be replaced by the keycap 610.

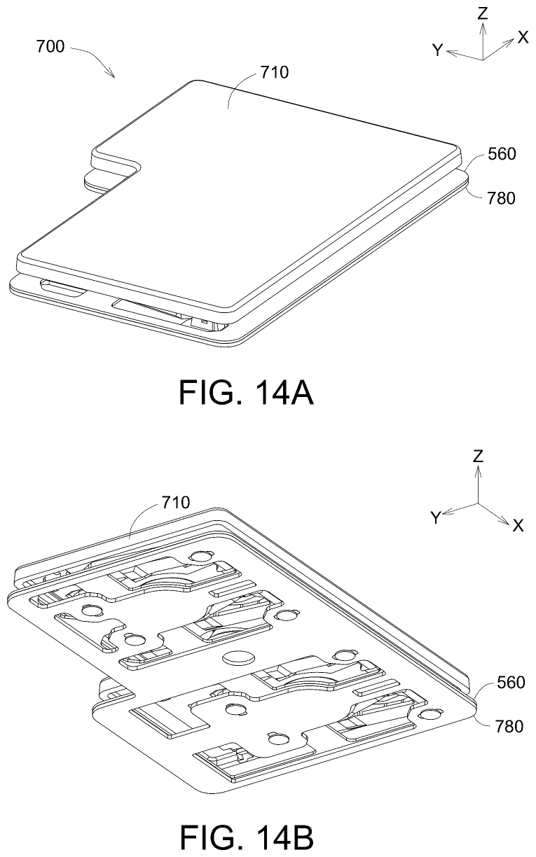

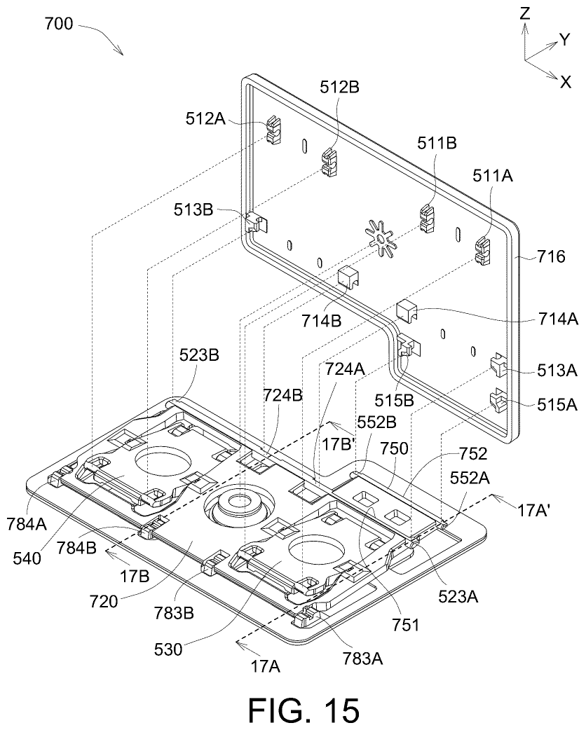

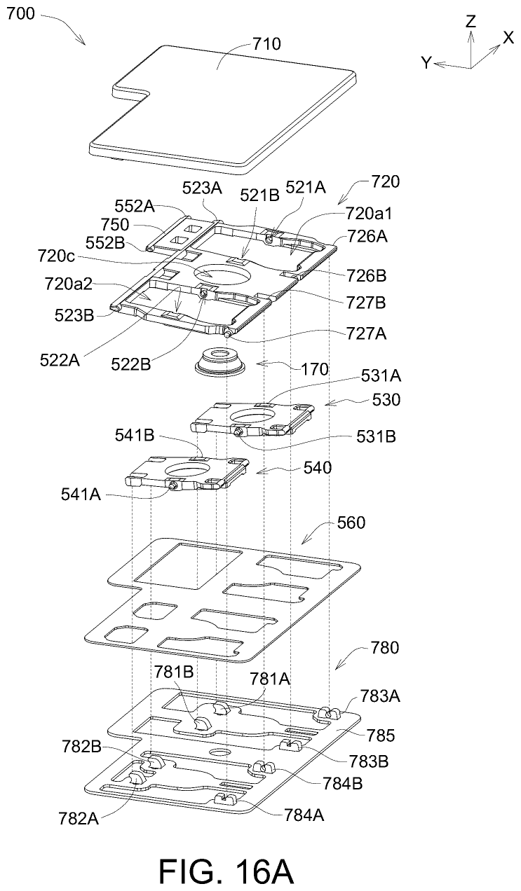

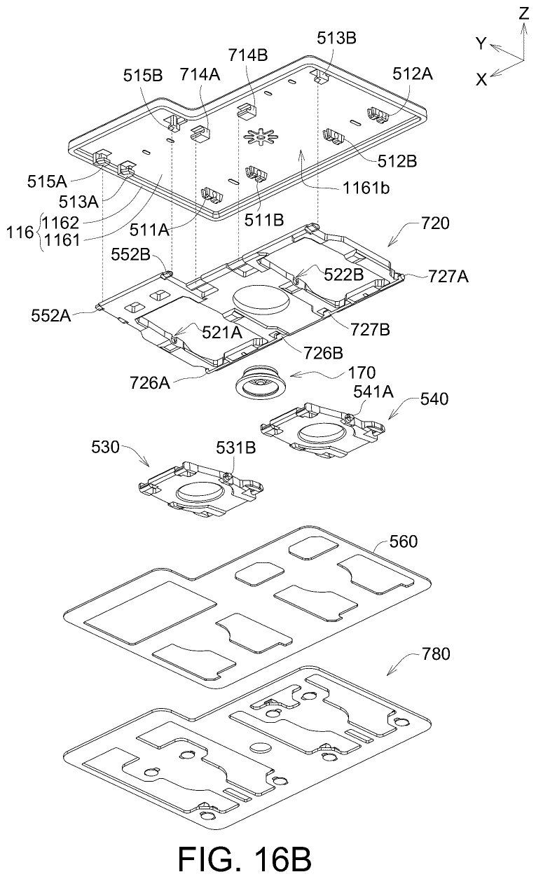

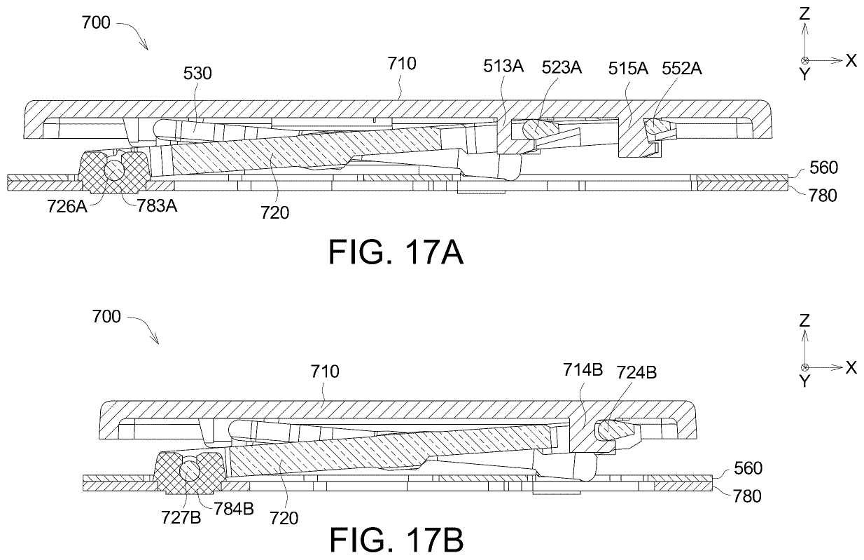

Referring to FIGS. 14A to 17B, FIGS. 14A and 14B are schematic diagrams of a key structure 700 according to another embodiment of the present invention at different viewing angles, FIG. 15 is an assembly diagram of the key structure 700 in FIG. 14A (but the keycap 710 is disassembled), FIGS. 16A and 16B are exploded diagrams of the key structure 700 in FIG. 14A at different viewing angles, FIG. 17A is a schematic diagram of a cross-sectional view of the key structure 700 in FIG. 15 along a direction 17A-17A′ (including the assembled keycap 710), and FIG. 17B is a schematic diagram of a cross-sectional view of the key structure 700 in FIG. 15 along a direction 17B-17B′ (including the assembled keycap 710).

As illustrated in FIGS. 15A to 16B, the key structure 700 includes at least one keycap 710, at least one first bracket 720, at least one second bracket 530, at least one third bracket 540, the circuit board 560, at least one elastic body 170 and a base plate 780.

As illustrated in FIGS. 15 and 16A to 16B, the first bracket 720, the second bracket 530 and the third bracket 540 may form a lifting mechanism, or the first bracket 720, the second bracket 530 and the third bracket 540 may form a lifting mechanism. In an embodiment, one lifting mechanism, one keycap 710 and one elastic body 170 may form one key module. The key structure 700 is, for example, a keyboard, which may include at least one key module. In an embodiment, the lifting mechanism is, for example, a scissor mechanism. The second bracket 530 and the third bracket 540 are entirely surrounded by the first bracket 720 (for example, looking in the −Z-axis direction), so the second bracket 530 and the third bracket 540 may be called “inner scissor brackets”, and the first bracket 520 may be called “outer scissor bracket”. In addition, the aforementioned keyboard is, for example, an individual keyboard, or a built-in keyboard of an electronic product, wherein the electronic product is, for example, a notebook computer, a home appliance, or other electronic product that requires input functions.

As illustrated in FIGS. 15 and 16A to 16B, the key structure 700 includes technical features the same as or similar to that of the aforementioned key structure 500, and at least one difference is that the key structure 700 of the embodiment of the invention may omit the first support element 550.

As illustrated in FIGS. 15 and 16A to 16B, the first bracket 720 is connected to the keycap 710 and has a first mounting portion 720a1 and a second mounting portion 720a2. The second bracket 530 is connected to the first bracket 720 and is disposed on the first mounting portion 720a1. The third bracket 140 is connected to the first bracket 720 and is disposed on the second mounting portion 720a2.

The lifting mechanism has a through hole, and the structures of the lifting mechanism on two sides of the through hole are different. For example, as illustrated in FIGS. 15 and 16A to 16B, the first bracket 720 has a through hole 720c, and the structures of the lifting mechanism on two opposite sides of the through hole 720c are different. For example, the key structure 700 further includes a support element 750, and the support element 750 is connected to the first bracket 720. The support element 750 and the first bracket 720 are, for example, fixed to each other. In an embodiment, the support element 750 and the first bracket 720 form, for example, an integrally formed structure. In addition, the elastic body 170 is corresponding to the through hole 720c and disposed between the keycap 710 and the base plate 780.

As illustrated in FIG. 16B, the keycap 710 includes a plurality of the first connection portions 511A and 511B, a plurality of the second connection portions 512A and 512B, a plurality of the third connection portions 513A and 513B, a plurality of the fourth connection portions 714A and 714B, a plurality of the fifth connection portions 515A and 515B and a cap body 116. The cap body 116 includes a top plate 1161 and a lateral plate 1162, wherein the lateral plate 1162 is connected to the edge of the top plate 1161. The first connection portion 511A and 511B, the second connection portion 512A and 512B, the third connection portion 513A and 513B, and the fourth connection portion 714A and 714B are connected to the lower surface 1161b of the top plate 1161.

As illustrated in FIGS. 15 and 16A to 16B, the keycap 710 may be connected to the first bracket 720, the second bracket 530, the third bracket 540 and the support element 750. For example, the first connection portions 511A and 511B may be connected to the second bracket 530, the second connection portions 512A and 512B may be connected to the third bracket 540, the third connection portions 513A and 513B and the fourth connection portions 714A and 714B may be connected to the first bracket 720, and the fifth connection portions 515A and 515B may be connected to the support element 750.

As illustrated in FIGS. 15 and 16A to 16B, the first bracket 720 may connect the keycap 710, the second bracket 530, the third bracket 540 and the base plate 780. For example, the first bracket 720 includes a plurality of the first connection portions 521A and 521B, a plurality of the second connection portions 522A and 522B, a plurality of the third connection portions 523A and 523B, a plurality of the fourth connection portions 724A and 724B, a plurality of the sixth connection portions 726A and 726B, a plurality of the seventh connection portions 727A and 727B and a bracket body 728. The aforementioned through hole 720c is formed in the first bracket body 728.

As illustrated in FIGS. 15 and 16A to 16B, the first connection portion 521A is the same as or similar to the first connection portion 521B in structure, the second connection portion 522A is the same as or similar to the second connection portion 522B in structure, the third connection portion 523A is the same as or similar to the third connection portion 523B in structure, the fourth connection portion 724A is the same as or similar to the fourth connection portion 724B in structure, the sixth connection portion 726A is the same as or similar to the sixth connection portion 726B in structure, and the seventh connection portion 727A is the same as or similar to the seventh connection portion 727B in structure.

As illustrated in FIGS. 15 and 16A to 16B, the first connection portions 521A and 521B and the second connection portions 522A and 522B are, for example, pivotal holes, which are disposed on the first bracket body 528, and the third connection portions 523A and 523B, the fourth connection portions 724A and 724B, the sixth connection portions 726A and 726B and the seventh connection portions 727A and 727B are, for example, pivotal shafts, which may be connected to the first bracket body 528. In an embodiment, the third connection portions 523A and 523B, the fourth connection portions 724A and 724B, the sixth connection portions 726A and 726B, the seventh connection portions 727A and 727B and the first bracket body 528 form, for example, an integrally formed structure. For example, the integrated first bracket 720 is formed by using the injection molding technology. In terms of material, the first bracket 720 is, for example, made of plastic.

As illustrated in FIGS. 15 and 16A to 16B, the first connection portions 521A and 521B of the first bracket 720 may be connected to the second bracket 530, the second connection portions 522A and 522B of the first bracket 720 may be connected to the third bracket 540, the third connection portions 523A and 523B and the fourth connection portions 524A and 524B of the first bracket 720 may be connected to the keycap 710, and the sixth connection portions 726A and 726B and the seventh connection portions 727A and 727B of the first bracket 720 may be connected to the base plate 780.

As illustrated in FIGS. 15 and 16A to 16B, the third connection portions 523A and 523B of the first bracket 720 are respectively connected to the third connection portions 513A and 513B of the keycap 710, and the fourth connection portions 724A and 724B of the first bracket 720 are respectively connected to the fourth connection portions 714A and 714B of the keycap 710. Similar to the aforementioned first bracket 120, the third connection portions 523A and 523B and the fourth connection portions 724A and 724B of the first bracket 720 of the present embodiment may be arranged in a straight line (e.g., substantially parallel to the X-axis), and the third connection portions 513A and 513B and the fourth connection portions 714A and 714B of the keycap 710 are also arranged in a straight line (e.g., substantially parallel to the X-axis) correspondingly. In the present embodiment, a plurality of the connection portions of the keycap 710 (e.g., the third connection portions 513A and 513B and the fourth connection portions 714A and 714B) are coaxially connected with a plurality of the connection portions of the first bracket 720 (e.g., the third connection portions 523A and 523B and the fourth connection portions 724A and 724B), and accordingly it may reduce the complexity of the mechanism design. In addition, a plurality of the connection portions of the keycap 710 (for example, the third connection portion 513B and the fourth connection portions 714A and 714B) are disposed adjacent to a side of the keycap 710 to provide an edge support effect, and accordingly it may increase the stability of the keycap 710 when the keycap 710 is pressed. In addition, the fourth connection portions 724A and 724B of the first bracket 720 are located between the third connection portion 523A and the third connection portion 523B, and accordingly it may provide more support points (for example, four), and may increase the stability of the first bracket 720 supporting the keycap 710. In another embodiment, the number of the fourth connection portions of the first bracket 720 may be more than two or one, and the number of the fourth connection portions of the keycap 710 may be changed accordingly.

As illustrated in FIG. 15, the support element 750 has a first end 751 and a second end 752 opposite to the first end 751, the first end 751 may be fixed to the first bracket 530, and the second end 752 may be connected to the keycap 710. In the present embodiment, the first bracket 530 may be directly connected to the keycap 710 and/or indirectly connected to the keycap 710 through the support element 750. The support element 750 includes the second connection portions 552A and 552B which may be connected to the fifth connection portions 515A and 515B of the keycap 710 respectively. As illustrated in FIG. 17A, the second connection portion 552A of the support element 750 and the fifth connection portion 515A of the keycap 710 may be connected to each other in a relatively-slidable and relatively-rotatable manner. The connection method of the second connection portion 552B of the support element 750 and the fifth connection portion 515B of the keycap 710 is the same as the connection method of the second connection portion 552B and the fifth connection portion 515B, and they will not be repeated here.

As illustrated in FIGS. 15 and 16A to 16B, the base plate 780 includes a plate body 785. The key structure 700 further includes a plurality of first connection portions 781A and 781B, a plurality of second connection portions 782A and 782B, a plurality of third connection portions 783A and 783B, and a plurality of fourth connection portions 784A and 784B. The first connection portion 781A is similar to or the same as the first connection portion 781B in structure, the second connection portion 782A is similar to or the same as the second connection portion 782B in structure, the third connection portion 783A is similar to or the same as the third connection portion 783B in structure, and the fourth connection portion 784A is similar to or the same as the fourth connection portion 784B in structure.

As illustrated in FIGS. 15, 16A to 16B and 17A to 17B, the first connection portions 781A and 781B, the second connection portions 782A and 782B, the third connection portions 783A and 783B and the fourth connection portions 784A and 784B may be configured on the base plate 780. In the present embodiment, the base plate 780 is, for example, a flat plate without a bending portion. The first connection portion 781A and 781B, the second connection portion 782A and 782B, the third connection portion 783A and 783B, and the fourth connection portion 784A and 784B may be formed separately and then connected to the base plate 780 by, for example, over-molding (for example, insert Molding or two shot molding). In terms of material, the base plate 780 and the connection portions (for example, the first connection portion 781A and 781B, the second connection portion 782A and 782B, the third connection portion 783A and 783B and/or the fourth connection portion 784A and 784B) are, for example, the same material or different materials. For example, the base plate 780 and the connection portion both are formed of metal or plastic, or one of the base plate 780 and the connection portion is metal and the other is plastic.

As illustrated in FIGS. 15 and 16A to 16B, in the present embodiment, the first connection portions 581A and 581B and the second connection portions 582A and 582B of the base plate 780 may be arranged in a straight line (e.g., substantially parallel to the X-axis), so that the third connection portions 533A and 533B of the second bracket 530 and the third connection portions 543A and 543B of the third bracket 540 may be connected to the base plate 580 along a straight line. In other words, the second bracket 530 and the third bracket 540 are connected to the same straight line of the base plate 580, and such a coaxial connection may reduce the complexity of the mechanism design. In addition, the third connection portions 583A and 583B and the fourth connection portions 584A and 584B of the base plate 580 may be arranged in a straight line (for example, substantially parallel to the X-axis), the sixth connection portions 526A and 526B and the seventh connection portions 527A and 527B of the first bracket 520 may be arranged in a straight line (for example, substantially parallel to the X-axis), and the first bracket 520 may be connected to the base plate 580 along a straight line. In other words, the first bracket 520 is connected to the same straight line of the base plate 580, and such a coaxial connection may reduce the complexity of the mechanism design.

As illustrated in FIG. 17A, the sixth connection portions 726A and 726B of the first bracket 720 are connected to the third connection portion 783A. For example, the sixth connection portion 726A and the third connection portion 783A may be connected to each other in a relatively-rotatable but non-slidable manner. The connection method between the sixth connection portion 726B and the third connection portion 783B is the same as the connection method between the sixth connection portion 726A and the third connection portion 783A, and they are not be repeated here.

As illustrated in FIG. 17A, the connection method between the third connection portion 523A of the first bracket 720 and the third connection portion 513A of the keycap 710 is the same as the connection method between the third connection portion 523A and the third connection portion 513A of the aforementioned key structure 500, and they will not be repeated here. The connection method between the second connection portion 552A of the first support element 750 and the fifth connection portion 515A of the keycap 710 is the same as the connection method between the second connection portion 552A and the fifth connection portion 515A of the aforementioned key structure 500, and they will not be repeated here. In the present embodiment, due to the support element 750 and the first support element 720 being integrally formed structure, the third connection portion 523A of the first support element 720 located between the sixth connection portion 726A of the first support element 720 and the second connection portion 552A of the first support element 750 may be different from the second connection portion 552A of the first support element 750 in structure and/or thickness. For example, even if the third connection portion 523A of the first support element 720 and the second connection portion 552A of the first support element 750 are both connected to the keycap 710, the thickness of the third connection portion 523A of the first support element 720 in the movement direction (such as the Z-axis direction) of the keycap 710 is greater than the thickness of the second connection portion 552A of the first support element 750 in the movement direction of the keycap 710 (such as the Z-axis direction). Through the aforementioned connection structure among the first support element 720, the first support element 750 and the keycap 710, the keycap 710 may be stably supported (enhanced support function).

As illustrated in FIG. 17B, the fourth connection portion 714B of the keycap 710 is connected to the fourth connection portion 724B of the first bracket 720. For example, the fourth connection portion 714B and the fourth connection portion 724B may be connected in a relatively-rotated and relatively-slidable manner. The connection method of the fourth connection portion 714A and the fourth connection portion 724A is the same as the connection method of the fourth connection portion 714B and the fourth connection portion 724B, and they will not be repeated here. In addition, the seventh connection portion 727B of the first bracket 720 is connected to the fourth connection portion 784B of the base plate 780. For example, the seventh connection portion 727B and the fourth connection portion 784B may be connected in a relatively-rotated but not relatively-slidable manner. The connection method of the seventh connection portion 727A and the fourth connection portion 784A is the same as the connection method of the seventh connection portion 727B and the fourth connection portion 784B, and they will not be repeated here.

In summary, the embodiment of the invention proposes a key structure. The key structure at least includes a keycap, a first bracket and a second bracket. In an embodiment, the second bracket may be connected to the first bracket and at least partially located in a mounting portion of the first bracket. The second bracket may protrude or retract relative to a lateral surface of the first bracket. Due to the various variations in the design of the second bracket, the corresponding portion of the keycap (e.g., the protruding area of the keycap, etc.) may be supported in response to a shape of the keycap. In other embodiments, the key structure further includes at least one support element, and the support element may be connected to one of the first bracket and the second bracket. The support element may protrude relative to a lateral surface of the first bracket and may support the corresponding portion of the keycap (e.g., the protruding area of the keycap, etc.) in response to the shape of the keycap. In addition, a connection portion of a first element and a connection portion of a second element of the key structure of the disclosed embodiment are connected to each other, wherein the number of the connection portion of the first element is at least one, such as one, two or more, and the number of the connection portion of the second element may be equal to the number of the connection portion of the first element. In addition, a plurality of the connection portions of the first element of the key structure may be in a straight line, and a plurality of the connection portions of the second element of the key structure may be arranged in a straight line, and the first element and the second element may be connected along a straight line so that the first element and the second element may rotate around the straight line. One of the aforementioned first element and the second element is, for example, a bracket (for example, a first bracket, a second bracket or a third bracket), a support element (for example, a first support element or a second support element) or a base plate. In addition, the two elements connected to each other in the key structure may be an individually integrally formed structure and/or made of the same material. In addition, the keycap of the embodiment of the present invention is not limited to a special-shaped keycap, and it may be a standard keycap (for example, a keycap does not have a protrusion or a notch). In addition, the connection portions arranged along a straight line may be equal to or more than two, but it may also be one.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A key structure, comprising:
a keycap;
a first bracket connected to the keycap and having a first opening and a second opening;
a second bracket connected to the first bracket and protruding relative to the first opening; and
a third bracket connected to the first bracket and protruding relative to the second opening, wherein the second bracket and the third bracket are separately arranged.

2. The key structure as claimed in claim 1, further comprising:
a first support element connecting the first bracket with the keycap, and the first support element is disposed corresponding to the second bracket.

3. The key structure as claimed in claim 2, wherein the keycap has a protruding area, the first support element comprises a first connection portion and a second connection portion, the first connection portion is connected to the first bracket, the second connection portion is connected to the protruding area of the keycap, the keycap comprises a plurality of connection portions, the second bracket is connected to the connection portions, and a distance between at least one of the connection portions and an edge of the protruding area is greater than a distance between the second connection portion and the edge of the protruding area.

4. The key structure as claimed in claim 2, further comprising:
a second support element connecting the first bracket with the keycap, wherein the second support element is disposed corresponding to the third bracket; and
a connecting element connecting the first support element with the second support element, wherein there is a gap between the first support element and the second support element, and the gap is corresponding to the connecting element.

5. The key structure as claimed in claim 2, further comprising:
a second support element connecting the first bracket with the keycap, wherein the second support element is disposed corresponding to the third bracket;
wherein the second bracket and the third bracket are disposed along a first direction, the first support element and the second support element are arranged along a second direction, the first direction is parallel to the second direction, the first support element and the second support element respectively have a first concavity and a second concavity, the first concavity corresponds to a portion of the second bracket in position, and the second concavity corresponds to a portion of the third bracket in position.

6. The key structure as claimed in claim 2, wherein the keycap has a notch, and the notch does not overlap with the first support element along a movement direction of the keycap.

7. The key structure as claimed in claim 2, wherein the first support element has a first end and a second end opposite to the first end, the first end is fixed to the first bracket, and the second end is connected to the keycap.

8. The key structure as claimed in claim 7, wherein the first bracket comprises a connection portion, and the connection portion of the first bracket is connected to the keycap.

9. The key structure as claimed in claim 1, wherein the first bracket comprises a lateral surface, a first mounting portion and a second mounting portion, the first mounting portion and the second mounting portion respectively expose the first opening and the second opening from the lateral surface, the second bracket is disposed on the first mounting portion and connected to the first bracket, and the third bracket is disposed on the second mounting portion and connected to the first bracket.

10. The key structure as claimed in claim 1, wherein the first bracket comprises a plurality of connection portions, the keycap is connected to the connection portions of the first bracket, and the connection portions of the first bracket are arranged in a straight line.

11. The key structure as claimed in claim 1, further comprising:
a base plate; and
an elastic body disposed between the keycap and the base plate;
wherein the keycap comprises a pressing portion, and the pressing portion overlaps with the elastic body along a movement direction of the keycap.

12. The key structure as claimed in claim 1, further comprising:
a base plate; and
a first support element disposed between the base plate and the keycap;
wherein the first support element, the first bracket and the base plate are connected along an axis.

13. The key structure as claimed in claim 1, wherein the keycap comprises a plurality of connection portions, the second bracket and the third bracket are connected to the connection portions of the keycap, and the connection portions of the keycap are arranged in a straight line.

14. A key structure, comprising:
a keycap;
a first bracket connected to the keycap and having a mounting portion and an opening;
a second bracket connected to the first bracket, disposed on the mounting portion, wherein the second bracket protrudes relative to the opening or retracts relative to the opening; and
a support element connecting the first bracket or the second bracket.

15. The key structure as claimed in claim 14, wherein the second bracket protrudes relative to the opening, the support element connects the first bracket with the keycap, the keycap has a protruding area, and the support element is connected to the protruding area.

16. The key structure as claimed in claim 14, wherein the second bracket protrudes relative to the opening, the support element connects the first bracket with the keycap, the keycap has a notch, and the notch does not overlap with the support element along a movement direction of the keycap.

17. The key structure as claimed in claim 14, wherein the second bracket protrudes relative to the opening, the support element connects the first bracket with the keycap, the keycap comprises a pivotal hole, the support element comprises a pivotal shaft, and an inner diameter of the pivotal hole is greater than an outer diameter of the pivotal shaft.

18. The key structure as claimed in claim 14, wherein the second bracket protrudes relative to the opening, the support element connects the first bracket with the keycap, the first bracket comprises a plurality of connection portions, the keycap is connected to the connection portions of the first bracket, and the connection portions of the first bracket are arranged in a straight line.

19. The key structure as claimed in claim 14, wherein the second bracket protrudes relative to the opening, the support element connects the first bracket with the keycap, and the key structure further comprises:
a base plate, wherein the base plate comprises a plurality of connection portions;
wherein the support element is disposed between the base plate and the keycap, and the first bracket and the connection portions of the base plate are connected along an axis.

20. The key structure as claimed in claim 14, wherein the second bracket retracts relative to the opening, the support element connects the second bracket through the opening, the keycap has a protruding area, and the support element is connected to the protruding area.

21. The key structure as claimed in claim 14, wherein the second bracket retracts relative to the opening, the support element connects the second bracket through the opening, the keycap has a notch, and the notch does not overlap with the support element along a movement direction of the keycap.

22. The key structure as claimed in claim 14, wherein the second bracket retracts relative to the opening, the support element connects the second bracket through the opening, the keycap comprises a pivotal hole, the support element comprises a pivotal shaft, and an inner diameter of the pivotal hole is greater than an outer diameter of the pivotal shaft.

23. The key structure as claimed in claim 14, wherein the second bracket retracts relative to the opening, the support element connects the second bracket through the opening, the first bracket comprises a plurality of connection portions, the keycap is connected to the connection portions of the first bracket, and the connection portions of the first bracket are arranged in a straight line.

24. The key structure as claimed in claim 14, wherein the second bracket retracts relative to the opening, the support element connects the second bracket through the opening, and the key structure further comprises:
a base plate, wherein the base plate comprises a plurality of connection portions;
wherein the support element is disposed between the base plate and the keycap, and the first bracket and the connection portions of the base plate are connected along an axis.

25. A key structure, comprising:
a base plate;
a keycap disposed on the base plate;
a lifting mechanism, connecting the keycap with the base plate and having a through hole, wherein the lifting mechanism comprises different structures on both sides of the through hole; and
an elastic body, disposed corresponding to the through hole and between the keycap and the base plate.

26. The key structure as claimed in claim 25, wherein the lifting structure comprises:
a first bracket; and
a second bracket, connected to the first bracket;
wherein the keycap comprises a plurality of connection portions, the first bracket is connected to the connection portions of the keycap, and the connection portions of the keycap are arranged in a straight line.

27. The key structure as claimed in claim 26, wherein the lifting structure further comprises:
a support element, connecting the first bracket with the keycap and fixed to the first bracket;
wherein the first bracket and the base plate are connected along an axis.
